(19) United States
(12) Patent Application Publication
(10) Pub. No.: US 2025/0005699 A1
(43) Pub. Date: Jan. 2, 2025

(54) Passenger-Vehicle Matching Method for Online Ride-sharing service

(71) Applicant: SOUTHEAST UNIVERSITY, Nanjing (CN)

(72) Inventors: Jie MA, Nanjing (CN); Qianlian Wang, Nanjing (CN); Jingxu Chen, Nanjing (CN)

(73) Assignee: SOUTHEAST UNIVERSITY, Nanjing, CN (CN)

(21) Appl. No.: 18/705,549

(22) PCT Filed: Jan. 6, 2023
(86) PCT No.: PCT/CN2023/070866

§ 371 Date: Apr. 27, 2024

(30) Foreign Application Priority Data
Jun. 30, 2022 (CN) 2022107673134

(51) Int. Cl. G06Q 50/47; G06Q 10/047

(52) U.S. Cl. CPC G06Q 50/47; G06Q 10/047

(57) ABSTRACT

Provided in the present invention is a passenger-vehicle matching method for an online ride sharing. In the present invention, firstly, matching is performed on passengers by using an integer linear programming algorithm, so as to form a passenger combination scheme involving the optimal total travel time of the passengers; and secondly, in the present invention, virtual passenger combinations or virtual vehicles are supplemented, such that the number of passenger combinations is the same as the number of vehicles, and the passenger combinations are matched with the vehicles by using the integer linear programming algorithm again, so as to obtain a passenger-vehicle matching scheme involving the optimal total travel time. The present invention optimizes the passenger-vehicle matching process in online ride-hailing shared travel, enhancing user experience and efficiency, while also promoting a green traffic mode that significantly reduces urban traffic pressure and pollution.

### TECHNICAL FIELD

The present disclosure is in the field of on-line ride-sharing service matching, and particularly relates to a passenger-vehicle matching method for on line ride-sharing service.

### BACKGROUND ART

Ride sharing refers to a transportation mode in which people can use other people's vehicles in a shared or combined travel mode without having the ownership of vehicles and pay the royalty according to their own travel requirements. On the one hand, shared travel meets the consumer's self-driving demand that cannot be realized; on the other hand, it avoids the waste caused by the inefficient use of idle vehicle resources, and thus gradually becomes one of the main travel options for the public. In addition, in order to alleviate the urban traffic operation pressure, the shared travel mode will be further popularized with the continuous increase of car ownership; at the same time, the infrastructure construction continues to be improved, and there is considerable space in future shared travel market still for development.

Network contract shared travel is an important part of shared travel mode. The specific process is that, before the travel occurs, the passenger reserves a taxi through a service platform such as a mobile phone App or a website according to his/her own travel requirements; in the travel process, the passenger shares the reserved taxi with other passengers in a pooling manner; after the travel is completed, the passenger again pays the driver a corresponding fee through the service platform. In this process, the reasonable matching of the members (driver and a plurality of passengers) in the reserved vehicle by the service platform can greatly improve the travel efficiency of the network contract shared travel mode and optimize the travel experience of urban residents. Therefore, it is of great significance to optimize the matching process of passengers of the network contract shared travel for the promotion of this new traffic mode.

For example, a network representation learning-based passenger matching method for network contract shared travel (application number CN201910262393.6) uses a network representation learning model to perform representation learning on a heterogeneous shared network, obtains a low-dimensional vector representation of a user node, and calculates and ranks a cosine similarity between a driver and a passenger, namely, travel time, position, path, number of people, etc. and the passenger with the highest similarity to the driver is selected to complete the matching. In a method for matching a person to a vehicle as an on-line leeward vehicle (application number CN201911006628.1), a matching relationship between a leeward vehicle and a user in a matching set is screened out according to a travel cost saving value, and a maximum travel cost saving of the matched leeward vehicle and the user together is taken as a target to obtain a person to vehicle matching result. Although both of existing disclosures have studied on the matching process of shared travel, their proposed methods are mainly aimed at the mode of “one driver matching one passenger”, and do not consider the more extensive case of “one driver carrying multiple passengers simultaneously”.

### SUMMARY OF THE INVENTION

Technical problem: the present disclosure establishes a passenger-vehicle matching method for on line ride-sharing service, which is used for achieving reasonable and efficient matching of a driver and a plurality of passengers in a network reserved taxi. The present disclosure firstly classifies users according to their passenger pooling demand, and calculates a shortest travel time and path of various passenger combinations through a cloud collaborative system; secondly, in the present disclosure, an integer linear programming algorithm is applied to match passengers to form an optimal passenger combination scheme; finally, the present disclosure obtains an optimal driver-passenger matching scheme by supplementing a virtual passenger combination or a virtual driver such that the quantity of passenger combinations is the same as the quantity of drivers, and again applying an integer linear programming algorithm to match the passenger combinations with the drivers. The present disclosure can sufficiently optimize the passenger matching process in on-line ride-sharing service shared travel mode, resulting in better travel experience and higher travel efficiency for users. With the help of the present disclosure, on-line ride-sharing service shared travel, which is a green and emerging traffic mode, can be more widely promoted and plays a significant positive role in alleviating urban traffic pressure and improving urban traffic pollution.

Technical solution: in order to solve the above problem, the present disclosure provides a passenger matching method for on line ride-sharing service, including the following steps:
a user publishes a pooling demand of on-line contract shared travel information via App; a system cloud end server divides users into a plurality of user sets, and pre-processes information about each user set to form a data file which is sent to the App of the users in the set;
after receiving a data file, the user calculates a shortest passenger travel time and travel path in App, and returns a result to the system cloud end server; the system cloud end server receives the result to solve a 0-1 programming model of a passenger combination matching process, and screening is performed to obtain a passenger combination matching scheme;
a passenger combination is matched with a driver, and the system cloud end server constructs a generalized driver set and a generalized passenger combination set, a 0-1 programming model of a driver-passenger combination matching process is solved, and screening is performed to obtain the driver-passenger combination matching scheme; and
the system cloud end server sends the driver-passenger matching scheme to the App of the driver and the user, executes the matching scheme, and completes the on-line ride-sharing service shared travel.

Furthermore, in step 1), the travel information comprises a start point, an end point and the pooling demand, and each user set is pre-processed, and the system cloud end server forms information about the start point and the end point in the user set into the data file which is sent to a smart phone App of the users in the set.

Furthermore, in step 2), the pooling demand is two-person pooling demand and three-person pooling demand.

Further, the specific method in step 1) is as follows such that:
the user i issues, via App, on-line contract shared travel information, comprising a travel start point Oᵢ, a travel end point Dᵢ and the pooling demand Nᵢ, wherein a vehicle in a system is a five-seat automobile, and the automobile meets the pooling demand of the two-person pooling and the three-person pooling;
according to the users' pooling demand, the system cloud end server divides the users into two sets: RP_{A2} and RP_{A3}, the pooling demand of the users in the set RP_{A2} being the two-person pooling, namely Nᵢ=2, a quantity of users being |RP_{A2}|, while the pooling demand of the users in the set RP_{A3} being the three-person pooling, namely Nᵢ=3, a quantity of users being |RP_{A3}|;
taking the quantities |RP_{A2}| and |RP_{A3}| of the users in the set as a dividend, taking the pooling demands Nᵢ=2 and Nᵢ=3 of the users in the set as a divisor, a remainder operation is performed to obtain remainders |RP_{B2}| and |RP_{B3}|, namely:

$$\vert {RP}_{B 2} \vert = \vert {RP}_{A 2} \vert \%2 \\ \vert {RP}_{B 3} \vert = \vert {RP}_{A 3} \vert \%3$$

where % represents a remainder symbol;
the system pre-processes the sets RP_{A2} and RP_{A3} as follows by:
for the two-person pooling set RP_{A2}: randomly selecting |RP_{B2}| of the users in the set RP_{A2}, wherein selected users constitute a set RP_{B2} referred to as a secondary user set 2; and unselected users constitute a set RP₂ referred to as a main user set 2; and RP_{A2}=RP_{B2}∪RP₂, where if the remainder is |RP_{B2}|=0, then RP_{B2}=Ø, and there is a set relationship of RP_{A2}=RP₂;
for the three-person pooling set RP_{A3}: randomly selecting |RP_{B3}| of the users in the set RP_{A3}, wherein selected users constitute a set RP_{B3} referred to as a secondary user set 3; and unselected users constitute a set RP₃ referred to as a main user set 3; and RP_{A3}=RP_{B3}∪RP₃, where if the remainder is |RP_{B3}|=0, then RP_{B3}=Ø, and there is a set relationship of RP_{A3}=RP₃; and
after receiving the on-line contract shared travel information about the user and completing user set classification and pre-processing, the cloud end respectively aggregates the travel start points and the travel end points of the users in the sets RP₂ and RP₃, and extracts travel times between all nodes to form two data files: File2 and File3, and after forming the data files the cloud end sends the data file File2 to all the users in the set RP₂, and sends the data file File3 to all the users in the set RP₃.

Furthermore, in the step 2), a process of matching a passenger combination within the user set RP_{A2} with a two-person pooling demand is such that:
2) the user in RP₂ calculates a shortest passenger travel time and travel path of all possible two-person passenger combinations with himself as a first passenger, and returns a calculation result to the system cloud end server;
after the user of the user i∈RP₂ receives the data file File2 sent by the system cloud end server, the smart phone of the user i takes the user i as the first passenger to calculate the shortest travel path and travel time of the two-person passenger combination formed by the user i and any other user j∈RP₂\{i}, and returns a calculation result to the system cloud end server, and the calculation formula is as follows:

$${P}_{ij} = \{ {O}_{i} \to {O}_{j} \to {D}_{i} \to {D}_{j} , {O}_{i} \to {O}_{j} \to {D}_{j} \to {D}_{i} \} \\ {r}_{ij} = min \{ t ( {O}_{i} , {O}_{j} ) + t ( {O}_{j} , {D}_{i} ) + t ( {D}_{i} , {D}_{j} ) , t ( {O}_{i} , {O}_{j} ) + t ( {O}_{j} , {D}_{j} ) + t ( {D}_{j} , {D}_{i} ) \}$$

as stated above, “taking the user i as the first passenger” means taking the start point Oᵢ of the user i as a jumping-off place, so that the user i is the passenger gets aboard at first, and the driver needs to firstly receive the user i and j as the two passengers, and then send them to destinations respectively;
in the formula, in both Oᵢ→Oⱼ→Dᵢ→Dⱼ and Oᵢ→Oⱼ→Dⱼ→Dᵢ, paths are represented by nodes which are passed through successively, and all possible travel paths of the two-person passenger combination {i, j} are taken when the user i is the first passenger, and Pᵢⱼ represents a travel path set of the two-person passenger combination {i, j} when the user i is the first passenger, and t(Oᵢ, Oⱼ), t(Oⱼ, Dᵢ), t(Dᵢ, Dⱼ), t(Oⱼ, Dⱼ), and t(Dᵢ, Dⱼ) all represent travel time between two nodes in parentheses; t(Oᵢ, Oⱼ)+t(Oⱼ, Dᵢ)+t(Dᵢ, Dⱼ) and t(Oⱼ, Oⱼ)+t(Oⱼ, Dⱼ)+t(Dⱼ, Dᵢ) both represent possible travel time of the two-person passenger combination {i, j} when the user i is the first passenger, and rᵢⱼ represents a shortest passenger travel time of the two-person passenger combination {i, j} when the user i is the first passenger;
a quantity of users in RP₂ is |RP₂|, then the user i∈RP₂ forms (|RP₂|−1) two-person passenger combinations with other users, and the smart phone of the user i∈RP₂ needs to perform no less than (|RP₂|−1) times of calculations.
2) the system cloud end server compares the shortest passenger travel times when different users in respective two-person passenger combinations serve as the first passenger, and determines the shortest passenger travel time and travel path of each two-person passenger combination;
within the two-person passenger combination {i, j}, a sum of the shortest passenger travel times rᵢⱼ and rⱼᵢ with the user i and the user j as the first passenger are compared with each other, the shortest passenger travel time r_{i̅j̅} of the two-person passenger combination is determined, and a travel path corresponding to r_{i̅j̅} is recorded, wherein the formula is as follows:

$${r}_{\overline{ij}} = min \{ {r}_{ij} , {r}_{ji} \}$$

Since

$$\frac{\vert {RP}_{2} \vert ( \vert {RP}_{2} \vert - 1 )}{2}$$

possible two-person passenger combinations can be formed within the “main user set 2” RP₂, the system cloud end server needs to perform no less than

$$\frac{\vert {RP}_{2} \vert ( \vert {RP}_{2} \vert - 1 )}{2}$$

times of comparisons;
3) the users within RP_{B2} are formed into a passenger combination RP_{C2}, and the shortest passenger travel time r_{C̅2̅} and travel path of the passenger combination are calculated;
If, under the user's “two-person pooling” demand, if |RP_{B2}|≠0, |RP_{B2}|=1, namely there is only one user in the “secondary user set 2” RP_{B2} and the user is set as m∈RP_{B2};
the one user in RP_{B2} is formed into a passenger combination represented by RP_{C2}, referred to as “secondary passenger combination 2”, there is RP_{C2}={m}, the shortest passenger travel time r_{C̅2̅}=t(Oₘ, Dₘ) of the “secondary passenger combination 2” RP_{C2}, and the corresponding travel path is Oₘ→Dₘ;
{RP_{C2}} is allowed to represent a passenger combination set with only this one element RP_{C2}, referred to as secondary passenger combination set 2;
4) a matching problem of the two-person passenger combination is solved, and a two-person pooling passenger matching scheme with an optimal total passenger travel time is obtained;
for any user i∈RP₂, he can only form a two-person passenger combination with another user j∈RP₂\{i} ultimately, with a goal of minimizing the total passenger travel time, while under the user's two-person pooling demand, the matching problem of the two-person passenger combination can be transformed into a 0-1 programming model as follows:

$$min {\sum }_{i = 1}^{\vert {RP}_{2} \vert} {\sum }_{j = 1}^{\vert {RP}_{2} \vert} {r}_{\overline{ij}} {x}_{ij} \\ s . t . \{ \begin{matrix}{\sum }_{i = 1}^{\vert {RP}_{2} \vert} {x}_{ij} = 1 , ∀ j ∈ {RP}_{2} \\ {\sum }_{j = 1}^{\vert {RP}_{2} \vert} {x}_{ij} = 1 , ∀ i ∈ {RP}_{2} \\ {x}_{ij} = 0 or 1 , ∀ i , j ∈ {RP}_{2}\end{matrix}$$

where xᵢⱼ is a 0-1 variable: in a solution result of the model, if the user i and the user j constitute a two-person passenger combination {i, j}, then xᵢⱼ=1, otherwise xᵢⱼ=0;
since there is no constraint i≠j in the 0-1 programming model, there is a repeated two-person passenger combination {i, i} and relevant parameter r_{i̅i̅} and variable xᵢᵢ in the model, but it is impossible for a user i to form the two-person passenger combination with himself in practice, and in order to enable the 0-1 programming model to solve the two-person pooling passenger matching process, the shortest passenger travel time r_{i̅i̅} for the repeated two-person passenger combination {i, i} is set as follows:

$${r}_{\overline{ii}} = Inf , ∀ i ∈ {RP}_{2}$$

in the formula, Inf represents a positive infinite constantInf.

Hungarian algorithm is used to solve the 0-1 programming model, and an obtained solution vector is x=(xᵢⱼ, i∈RP₂, j∈RP₂)^{T}, the two-person passenger combination corresponding to xᵢⱼ=1 is screened out, the passenger combination set RP_{2_2} is formed, which is referred to as the main passenger combination set 2, a quantity of set elements of which is RP_{2_2}|=|RP₂|/2; and
a set RC₂=RP_{2_2}∪{RP_{C2}} is allowed to represent the passenger combination set formed by the users with the two-person pooling demand, i.e. a union set of RP_{2_2} and {RP_{C2}}, the travel path and travel time of each passenger combination in the set RC₂ are recorded, and a quantity |RC₂| of set elements represents a quantity of the passenger combinations under the two-person pooling demand.

Furthermore, in the step 2), a process of matching a passenger combination within the user set RP_{A3} with a three-person pooling demand is such that:
1) the system cloud end server pre-supplements a certain quantity of virtual users on the basis of RP₃ to form a generalized user set RP_{E3}; the user in RP₃ calculates the shortest passenger travel time and travel path of all possible two-person passenger combinations with himself as the first passenger, and returns a calculation result to the system cloud end server;
a quantity |RP₃|/3 of virtual users are pre-supplemented before passenger combination matching under the three-person pooling demand of the user, and the travel start points Oᵢ and the travel end points Dᵢ of the virtual users are all virtual nodes; the virtual node does not exist in a real urban road network, and the distance to any real node is positively infinite, |RP₃|/3 virtual users constitute a virtual user set RP_{V3}, and a union set of the virtual user set RP_{V3} and RP₃ is the generalized user set RP_{E3}, namely RP_{E3}=RP₃∪RP_{V3}, Inf representing a positive infinite constant;
after the smart phone of the user i∈RP₃ receives the data file File3 sent by the cloud end, the smart phone of the user i takes the user i as the first passenger to calculate the shortest travel path and travel time of the two-person passenger combination formed by the user i and any other user j∈RP₃\{i}, and returns a calculation result to the system cloud end server, and the calculation formula is as follows:

$${P}_{ij} = \{ {O}_{i} \to {O}_{j} \to {D}_{i} \to {D}_{j} , {O}_{i} \to {O}_{j} \to {D}_{j} \to {D}_{i} \} \\ {r}_{ij} = min \{ t ( {O}_{i} , {O}_{j} ) + t ( {O}_{j} , {D}_{i} ) + t ( {D}_{i} , {D}_{j} ) , t ( {O}_{i} , {O}_{j} ) + t ( {O}_{j} , {D}_{j} ) + t ( {D}_{j} , {D}_{i} ) \}$$

as stated above, taking the user i as the first passenger means taking the start point Oᵢ of the user i as a jumping-off place, so that the user i is the passenger gets aboard at first, and the driver firstly receives the users i and j as the two passengers, and then send them to destinations respectively;
in the formula, in both Oᵢ→Oⱼ→Dᵢ→Dⱼ and Oᵢ→Oⱼ→Dⱼ→Dᵢ, paths are represented by nodes which are passed through successively, and all possible travel paths of the two-person passenger combination {i, j} are taken when the user i is the first passenger, and Pᵢⱼ represents a travel path set of the two-person passenger combination {i, j} when the user i is the first passenger, and t(Ou, Oⱼ), t(Oⱼ, Dᵢ), t(Dᵢ, Dⱼ), t(Oⱼ, Dⱼ), and t(Dᵢ, Dⱼ) all represent travel time between two nodes in parentheses, t(Oᵢ, Oⱼ)+t(Oⱼ, Dᵢ)+t(Dᵢ, Dⱼ) and t(Oᵢ, Oⱼ)+t(Oⱼ, Dⱼ)+t(Dⱼ, Dᵢ) both represent possible travel time of the two-person passenger combination {i, j} when the user i is the first passenger, and rᵢⱼ represents a shortest passenger travel time of the two-person passenger combination {i, j} when the user i is the first passenger;
a quantity of users in RP₃ is |RP₃|, then the user i∈RP₃ forms (|RP₃|−1) two-person passenger combinations with other users, and the smart phone of the user i∈RP₃ needs to perform no less than (|RP₃|−1) times of calculations.
2) the system cloud end server compares the shortest passenger travel times when different users in respective two-person passenger combinations serve as the first passenger, and determines the shortest passenger travel time and travel path of each two-person passenger combination;
within the two-person passenger combination {i, j}, a sum of the shortest passenger travel times rᵢⱼ and rⱼᵢ with the user i and the user j as the first passenger are compared with each other, the shortest passenger travel time r_{i̅j̅} of the two-person passenger combination is determined, and a travel path corresponding to r_{i̅j̅} is recorded, wherein the formula is as follows:

$${r}_{\overline{ij}} = min \{ {r}_{ij} , {r}_{ji} \}$$

since

$$\frac{\vert {RP}_{3} \vert ( \vert {RP}_{3} \vert - 1 )}{2}$$

possible two-person passenger combinations can be formed within the “main user set 3” RP₃, the system cloud end server needs to perform no less than

$$\frac{\vert {RP}_{3} \vert ( \vert {RP}_{3} \vert - 1 )}{2}$$

times of comparisons.
3) all the users within “secondary user set 3” RP_{B3} are formed into a passenger combination RP_{C3}, and the shortest passenger travel time [symbol] and travel path of the passenger combination are calculated;
if |RP_{B3}|≠0 under the user's “three-person pooling” demand, then |RP_{B3}|=1 or |RP_{B3}|=2, namely, there are 1 or 2 users in the “secondary user set” RP_{B3}, all the users in the set RP_{B3} are formed into a passenger combination represented by RP_{C3}, referred to as “secondary passenger combination 3”, and res is allowed to represent the shortest passenger travel time of the passenger combination RP_{C3}, and {RP_{C3}} is allowed to represent a passenger combination set comprising only one element of the passenger combination RP_{C3}, referred to as “secondary passenger combination set 3”;
if there is one user in the set RP_{B3}, the user is set to be m∈RP_{B3}, then the “secondary passenger combination 3” RP_{C3}={m}, the shortest passenger travel time [symbol] =t(Oₘ, Dₘ) of RP_{C3} and a corresponding travel path is Oₘ→Dₘ;
if there are two users in the set RP_{B3}, it can be represented as m₁, m₂∈RP_{B3}, then “secondary passenger combination 3” RP_{C3}={m₁,m₂} is a two-person passenger combination, and the shortest passenger travel time [symbol] of RP_{C3} is the shortest passenger travel time [symbol] of the two-person passenger combination {m₁, m₂}, and for [symbol] it is also necessary to first respectively calculate the shortest passenger travel times m₁ and m₂ with rₘ_{₁}ₘ_{₂} and rₘ_{₂}ₘ_{₁} as the first passenger, and then make comparison to obtain the shortest passenger travel time [symbol] of the two-person passenger combination {m₁, m₂}, and a travel path corresponding to [symbol] is recorded;
4) to solve a first passenger combination matching problem under the “three-person pooling” demand of the user, |RP_{E3}|/2 generalized two-person passenger combinations is matched in the generalized user set RP_{E3}, and then real users in |RP₃|/2 real two-person passenger combinations and |RP₃|/2 mixed two-person passenger combinations are selected from the generalized two-person passenger combinations;
real users and virtual users are collectively referred to as generalized users;
if the passengers i and j in the two-person passenger combination {i, j} are both real users, then {i, j} is taken as the real two-person passenger combination; if the passenger i in the two-person passenger combination {i, j} is a real user and the passenger j is a virtual user, or if the passenger i is a virtual user and the passenger j is a real user, then {i, j} is taken as the mixed two-person passenger combination; if the passengers i and j in the two-person passenger combination {i, j} are both virtual users, then {i, j} is taken as a virtual two-person passenger combination, while the real two-person passenger combination, the mixed two-person passenger combination and the virtual two-person passenger combination are collectively referred to as the generalized two-person passenger combination;
in the first passenger combination matching process under the three-person pooling demand of the user, |RP_{E3}|/2 generalized two-person passenger combinations are matched in the generalized user set RP_{E3}, and for any generalized user i∈RP_{E3}, the generalized two-person passenger combination can only be formed by him with another generalized user j∈RP_{E3} \{i}, and aiming at minimizing the total passenger travel time, the matching problem of the generalized two-person passenger combination can be transformed into a 0-1 programming model as follows:

$$min {\sum }_{i = 1}^{\vert {RP}_{E 3} \vert} {\sum }_{j = 1}^{\vert {RP}_{E 3} \vert} {r}_{\overline{i j}} {x}_{i j}$$

$$s . t . \{ \begin{matrix}{\sum }_{i = 1}^{\vert {RP}_{E 3} \vert} {x}_{ij} = 1 , ∀ j ∈ {RP}_{E 3} \\ {\sum }_{j = 1}^{\vert {RP}_{E 3} \vert} {x}_{ij} = 1 , ∀ i ∈ {RP}_{E 3} \\ {x}_{ij} = 0 or 1 , ∀ i , j ∈ {RP}_{E 3}\end{matrix}$$

where xᵢⱼ is a variable from 0 to 1; in a model solution result, if the generalized user i and the generalized user j constitute the generalized two-person passenger combination {i, j}, then xᵢⱼ=1, otherwise xᵢⱼ=0;
since there is no constraint i≠j in the 0-1 programming model, the 0-1 programming model not only has the repeated two-person passenger combination {i, i} and the related parameter r_{i̅i̅} and variable xᵢᵢ, but also has the virtual user and the mixed two-person passenger combination and the virtual two-person passenger combination which may be formed;
in order to match the real two-person passenger combination as much as possible, and at the same time enable the 0-1 programming model to solve the first passenger matching process of “three-person pooling”, Inf is allowed to represent a positive infinite constant, and simultaneously the shortest passenger travel time of any generalized two-person passenger combination {i, j} is set as follows:
if i∈RP₃, j∈RP₃ and i≠j, it is the real two-person passenger combination, and the shortest passenger travel time thereof is r_{i̅j̅};
if i∈RP₃, j∈RP_{V3} or j∈RP₃, i∈RP_{V3}, it is the mixed two-person passenger combination, and the shortest passenger travel time thereof is Inf;
if i∈RP_{V3}, j∈RP_{V3} and i≠j, it is the virtual two-person passenger combination, and the shortest passenger travel time thereof is 2*Inf;
for the repeated two-person passenger combination {i, i}, the shortest passenger time r_{i̅i̅} thereof is set as 2*Inf;
the Hungarian algorithm is applied to solve the 0-1 programming model, and the solved vector is x=(xᵢⱼ, i∈RP_{E3}, j∈RP_{E3})^{T}, 2*(|RP₃|/3) generalized two-person passenger combinations corresponding to xᵢⱼ=1 are screened out, wherein there are |RP₃|/3 real two-person passenger combinations and |RP₃/3 mixed two-person passenger combinations;
the |RP₃|/3 real two-person passenger combinations are screened out to construct the real two-person passenger combination set RP_{3_2} and the quantity of set elements is |RP_{3_2}|=|RP₃|/3;
then the real users in |RP₃|/3 mixed two-person passenger combinations are screened out to construct the user set RP_{3_1} and the quantity of set elements is

$$\vert {RP}_{3 \_ 1} \vert = \vert {RP}_{3} \vert / 3 ;$$

after the system cloud end server completes the first passenger combination matching of the “three-person pooling”, the start points and the end points of two users of each real two-person passenger combination in the real two-person passenger combination set RP_{3_2} are extracted to form a data file File3_2; start points and end points of each user in the user set RP_{3_1} are extracted to form a data file File3_1;
after forming the data files, the system cloud sends the data files File3_1 and File3_2 to all the smart phones of the users in RP₃ again;
5) the user in RP₃ calculates a shortest passenger travel time and travel path of all possible three-person passenger combinations with himself as a first passenger, and returns a calculation result to the system cloud end server;
the real two-person passenger combination set RP_{3_2} and the user set RP_{3_1} are obtained in the first passenger combination matching process of the “three-person pooling”, so that the real two-person passenger combination {i, j}∈RP_{3_2} and the real user k∈RP_{3_1}, then the user i, the user j and the user k constitute a three-person passenger combination {i, j, k};
a step of calculating the shortest passenger travel time of the three-person passenger combination {i, j, k} is as follows;
smart phones of the user {i, j, k} and the user k∈RP_{3_1} receive the data files File3_1 and File3_2 sent by the cloud end; after receiving the files File3_1 and File3_2, the smart phone of the user i takes the user i as the first passenger to calculate the shortest travel path and travel time of the three-person passenger combination formed by the user i, the user j and the user k, and returns a calculation result to the system cloud end server, and the calculation formula is as follows:

$${P}_{ijk} = \{ \begin{matrix}{O}_{i} \to {O}_{j} \to {O}_{k} \to {D}_{i} \to {D}_{j} \to {D}_{k} , \\ {O}_{i} \to {O}_{k} \to {O}_{j} \to {D}_{i} \to {D}_{j} \to {D}_{k} , \\ {O}_{i} \to {O}_{j} \to {O}_{k} \to {D}_{i} \to {D}_{k} \to {D}_{j} , \\ {O}_{i} \to {O}_{k} \to {O}_{j} \to {D}_{i} \to {D}_{k} \to {D}_{j} , \\ {O}_{i} \to {O}_{j} \to {O}_{k} \to {D}_{j} \to {D}_{i} \to {D}_{k} , \\ {O}_{i} \to {O}_{k} \to {O}_{j} \to {D}_{j} \to {D}_{i} \to {D}_{k} , \\ {O}_{i} \to {O}_{j} \to {O}_{k} \to {D}_{j} \to {D}_{k} \to {D}_{i} , \\ {O}_{i} \to {O}_{k} \to {O}_{j} \to {D}_{j} \to {D}_{k} \to {D}_{i} , \\ {O}_{i} \to {O}_{j} \to {O}_{k} \to {D}_{k} \to {D}_{i} \to {D}_{j} , \\ {O}_{i} \to {O}_{k} \to {O}_{j} \to {D}_{k} \to {D}_{i} \to {D}_{j} , \\ {O}_{i} \to {O}_{j} \to {O}_{k} \to {D}_{k} \to {D}_{j} \to {D}_{i} , \\ {O}_{i} \to {O}_{k} \to {O}_{j} \to {D}_{k} \to {D}_{j} \to {D}_{i}\end{matrix} \}$$

$${r}_{ijk} = min \{ \begin{matrix}t ( {O}_{i} , {O}_{j} ) + t ( {O}_{j} , {O}_{k} ) + t ( {O}_{k} , {D}_{i} ) + t ( {D}_{i} , {D}_{j} ) + t ( {D}_{j} , {D}_{k} ) , \\ t ( {O}_{i} , {O}_{k} ) + t ( {O}_{k} , {O}_{j} ) + t ( {O}_{j} , {D}_{i} ) + t ( {D}_{i} , {D}_{j} ) + t ( {D}_{j} , {D}_{k} ) , \\ t ( {O}_{i} , {O}_{j} ) + t ( {O}_{j} , {O}_{k} ) + t ( {O}_{k} , {D}_{i} ) + t ( {D}_{i} , {D}_{k} ) + t ( {D}_{k} , {D}_{j} ) , \\ t ( {O}_{i} , {O}_{k} ) + t ( {O}_{k} , {O}_{j} ) + t ( {O}_{j} , {D}_{i} ) + t ( {D}_{i} , {D}_{k} ) + t ( {D}_{k} , {D}_{j} ) , \\ t ( {O}_{i} , {O}_{j} ) + t ( {O}_{j} , {O}_{k} ) + t ( {O}_{k} , {D}_{j} ) + t ( {D}_{j} , {D}_{i} ) + t ( {D}_{i} , {D}_{k} ) , \\ t ( {O}_{i} , {O}_{k} ) + t ( {O}_{k} , {O}_{j} ) + t ( {O}_{j} , {D}_{j} ) + t ( {D}_{j} , {D}_{i} ) + t ( {D}_{i} , {D}_{k} ) , \\ t ( {O}_{i} , {O}_{j} ) + t ( {O}_{j} , {O}_{k} ) + t ( {O}_{k} , {D}_{j} ) + t ( {D}_{j} , {D}_{k} ) + t ( {D}_{k} , {D}_{i} ) , \\ t ( {O}_{i} , {O}_{k} ) + t ( {O}_{k} , {O}_{j} ) + t ( {O}_{j} , {D}_{j} ) + t ( {D}_{j} , {D}_{k} ) + t ( {D}_{k} , {D}_{i} ) , \\ t ( {O}_{i} , {O}_{j} ) + t ( {O}_{j} , {O}_{k} ) + t ( {O}_{k} , {D}_{k} ) + t ( {D}_{k} , {D}_{i} ) + t ( {D}_{i} , {D}_{j} ) , \\ t ( {O}_{i} , {O}_{k} ) + t ( {O}_{k} , {O}_{j} ) + t ( {O}_{j} , {D}_{k} ) + t ( {D}_{k} , {D}_{i} ) + t ( {D}_{i} , {D}_{j} ) , \\ t ( {O}_{i} , {O}_{j} ) + t ( {O}_{j} , {O}_{k} ) + t ( {O}_{k} , {D}_{k} ) + t ( {D}_{k} , {D}_{j} ) + t ( {D}_{j} , {D}_{i} ) , \\ t ( {O}_{i} , {O}_{k} ) + t ( {O}_{k} , {O}_{j} ) + t ( {O}_{j} , {D}_{k} ) + t ( {D}_{k} , {D}_{j} ) + t ( {D}_{j} , {D}_{i} )\end{matrix} \}$$

as stated above, in order to achieve the three-person pooling demand of the user, the driver first picks up the three passengers and then sends them to destinations respectively, where Pᵢⱼₖ represents a travel path set of the three-person passenger combination {i, j, k} when the user i is the first passenger, wherein the elements Oⱼ→Oᵢ→Oₖ→Dᵢ→Dⱼ→Dₖ are all paths, which are represented by nodes that are passed through successively, and rᵢⱼₖ represent the shortest passenger travel time of the three-person passenger combination {i, j, k} when the user i is the first passenger, while the elements t(Oₖ, Oⱼ)+t(Oⱼ, Oᵢ)+t(Oᵢ, Dᵢ)+t(Dᵢ, Dⱼ)+t(Dⱼ, Dₖ) all represent possible travel times of the three-person passenger combination {i, j, k}; a quantity of users in the “main user set 3” RP₃ is |RP₃|, then the real two-person passenger combination {i, j}∈RP_{3_2} and the user k∈RP_{3_1} can form |RP₃|/3 three-person passenger combinations, namely, the smart phones of the users i, j, and k need to perform no less than |RP₃|/3 times of calculations.
6) the system cloud end server compares the shortest passenger travel times when different users in respective three-person passenger combinations serve as the first passenger, and determines the shortest passenger travel time and travel path of each three-person passenger combination;
within the three-person passenger combination {i, j, k}, the system compares the shortest passenger travel times rᵢⱼₖ, rⱼᵢₖ, and rₖᵢⱼ with the user i, the user j and the user k as the first passenger, determines the shortest passenger travel time [symbol] of the three-person passenger combination, and records a corresponding travel path [symbol] and the formula is as follows:

$${r}_{\overline{ijk}} = min \{ {r}_{ijk} , {r}_{jik} , {r}_{k i j} \}$$

since the real two-person passenger combination set RP_{3_2} and the user set RP_{3_1} can form

$$\frac{{\vert {RP}_{3} \vert}^{2}}{9}$$

possible two-person passenger combinations, the system cloud end server needs to perform no less than

$$\frac{{\vert {RP}_{3} \vert}^{2}}{9}$$

times of comparisons.
7) a second passenger combination matching problem of three-person pooling is solved, and a three-person pooling passenger matching scheme with an optimal passenger travel time is obtained;
for any two-person passenger combination {i, j}∈RP_{3_2}, it can only form a three-person passenger combination with another user k∈RP_{3_1} ultimately, with a goal of minimizing the total passenger travel time, while under the user's three-person pooling demand, the matching problem of the two-person passenger combination can be transformed into a 0-1 programming model as follows:

$$min {\sum }_{\{ i , j \}} {\sum }_{k} {r}_{\overline{ijk}} {x}_{i j k}$$

$$s . t . \{ \begin{matrix}{\sum }_{\{ i , j \}} {x}_{i j k} = 1 , ∀ k ∈ {RP}_{3 \_ 1} \\ {\sum }_{k} {x}_{i j k} = 1 , ∀ \{ i , j \} ∈ {RP}_{3 \_ 2} \\ {x}_{i j k} = 0 or 1 , ∀ \{ i , j \} ∈ {RP}_{3 \_ 2} , k ∈ {RP}_{3 \_ 1}\end{matrix}$$

where xᵢⱼₖ is a variable from 0 to 1; in a solution result of the model, if the two-person passenger combination {i, j} and the user k constitute the three-person passenger combination {i, j, k}, then xᵢⱼₖ=1, otherwise xᵢⱼₖ=0;
Hungarian algorithm is used to solve the 0-1 programming model, and an obtained solution vector is x=(xᵢⱼₖ, {i, j}∈RP_{3_2}, k∈RP_{3_1})^{T}, the three-person passenger combination corresponding to xᵢⱼₖ=1 is screened out, the passenger combination set RP_{3_3} is constituted, which is referred to as the main passenger combination set 3, a quantity of set elements of which is |RP_{3_3}=|RP₃|/3; and
a set RC₃=RP_{3_3}∪{RP_{C3}} is allowed to represent the passenger combination set formed by the users with the three-person pooling demand, i.e. a union set of RP_{3_3} and RP_{C3}, the travel path and travel time of each passenger combination in the set RC₃ are recorded, and a quantity |RC₃| of set elements represents a quantity of the passenger combinations under the three-person pooling demand;
the set RC is allowed to represent the passenger combination set formed by all users in the system, which is a union set of the passenger combination sets formed by users who have two-person pooling demand and three-person pooling demand, i.e. RC=RC₂∪RC₃, and a quantity |RC| of set elements represents the quantity of passenger combinations in the system.

Further, in step 3), the process of matching passenger combinations within each passenger set is:
5.1) the passenger combination and the driver in the system are matched to form the driver-passenger combination, and a driver-passenger travel time and travel path of each driver-passenger combination are calculated;
5.2) a preset quantity of drivers or passenger combinations are supplemented, so that a quantity of passenger combinations participating in matching is equal to a quantity of drivers, a matching problem of the driver-passenger combination is solved, and a driver-passenger matching scheme with an optimal total driver-passenger travel time is obtained.

Further, the process of step 5.1) is as follows:

V is allowed to represent a driver set in the system, and a quantity |V| of set elements represents the quantity of drivers in the system;
for any driver v∈V, V_Oᵥ is allowed to represent a current position of v; for any passenger combination e∈RC, C_Oₑ and C_Dₑ are allowed to represent a start point and an end point of a passenger combination travel path of e, and C_Tₑ represents a passenger combination travel time of e;
the driver v∈V and the passenger combination e∈RC are matched to constitute the driver-passenger combination {v, e}, and a travel trajectory thereof is that the driver v starts from the current position V_Oᵥ to C_Oₑ for picking up the first passenger until C_Dₑ where all the passengers get off the vehicle;
pᵥₑ is allowed to represent a travel path of the driver-passenger combination {v, e}, and tᵥₑ is allowed to represent a path travel time of the driver-passenger combination {v, e}, i.e. a driver-passenger travel time, and the calculation formula is:

$$\begin{matrix}{p}_{v e} = \{ {V\_O}_{v} \to {C\_O}_{e} \to {C\_D}_{e} \} \\ {t}_{v e} = t ( {V\_O}_{v} , {C\_O}_{e} ) + {C\_T}_{e}\end{matrix}$$

where pᵥₑ represents a travel path from a current position V_Oᵥ to C_Dₑ by the driver, and t(V_Oᵥ, C_Oₑ) represents a travel time required by the driver v from the current position V_Oᵥ to the start point C_Oₑ of the travel path of the passenger combination e;
if in the system the quantity of drivers is |V| and the quantity of passenger combinations is |RC|, then there are |V|·|RC| possible driver-passenger combinations, and the driver-passenger travel time is calculated for |V|·|RC| times.

Furthermore, in the step 5.2), a method that a preset quantity of drivers or passenger combinations are supplemented so that a quantity of passenger combinations participating in matching is equal to a quantity of drivers is as follows such that:
a real driver and a virtual driver are collectively referred to as a generalized driver, and the real passenger combination and the virtual passenger combination are collectively referred to as the generalized passenger combination, and the generalized driver and the generalized passenger combination are matched and can form a generalized driver-passenger combination;
if the driver v in the driver-passenger combination {v, e} is the real driver and the passenger combination e is the real passenger combination, then {v, e} is a real driver-passenger combination; otherwise, {v, e} is a virtual driver-passenger combination, and the real driver-passenger combination and the virtual divisor-multiplier combination are collectively referred to as the generalized divisor-multiplier combination;
Inf is allowed to represent a positive infinite constant, a certain quantity of virtual drivers or virtual passenger combinations are supplemented according to actual situations, and a generalized driver set and a generalized passenger combination set are constructed, and the specific processing is as follows:
If the quantity of real passenger combinations is greater than the quantity of real drivers, namely |RC|>|V|, (|RC|−|V|) virtual drivers are supplemented in a driver set V to constitute a generalized driver set V_{g}, wherein the generalized passenger combination set RC_{g} is equal to the passenger combination set RC, namely RC_{g}=RC, with the passenger travel time tᵥₑ=Inf of the virtual driver v and any generalized passenger combination e∈RC_{g};
if the quantity of real passenger combinations is less than the quantity of real drivers, namely |RC|<|V|, (|V|−|RC|) virtual passenger combinations are supplemented in the passenger combination set RC to constitute the generalized passenger combination set RC_{g}, the generalized driver set V_{g} is equal to the driver set V, namely V_{g}=V, with the driver-passenger travel time tᵥₑ=Inf of the virtual passenger combination e and any generalized driver v∈V_{g}.

Furthermore, for the generalized driver set and the generalized passenger combination set, a method for driver-passenger combination matching is as follows such that:
for any generalized driver v∈V_{g}, the generalized driver-passenger combination can only be formed by him with one generalized passenger combination e∈RC_{g}, and with a goal of minimizing the total driver-passenger travel time, the matching problem of the driver-passenger combination can be transformed into a 0-1 programming model as follows:

$$min {\sum }_{v = 1}^{\vert {V}_{g} \vert} {\sum }_{e = 1}^{\vert {RC}_{g} \vert} {t}_{ve} {y}_{v e}$$

$$s . t . \{ \begin{matrix}{\sum }_{e = 1}^{\vert {RC}_{g} \vert} {y}_{ve} = 1 , ∀ e ∈ {RC}_{g} \\ {\sum }_{v = 1}^{\vert {V}_{g} \vert} {y}_{ve} = 1 , ∀ v ∈ {V}_{g} \\ {y}_{ve} = 0 or 1 , ∀ e ∈ {RC}_{g} , v ∈ {V}_{g}\end{matrix}$$

where yᵥₑ is a variable from 0 to 1; in a model solution result, if the generalized driver v and the generalized passenger combination e constitute the generalized driver-passenger combination {v, e}, then yᵥₑ=1, otherwise yᵥₑ=0;
the Hungarian algorithm is applied to solve the 0-1 programming problem, and the obtained solution vector is y=(yᵥₑ, v∈V_{g}, e∈RC_{g})^{T}, the generalized driver-passenger combinations corresponding to yᵥₑ=1 therein are screened out to constitute a generalized driver-passenger combination set VRC_{g}, and then the real driver-passenger combinations in the set VRC_{g} are screened out to constitute a driver-passenger combination set VRC, wherein a quantity |VRC| of set elements is equal to a minimum value of a quantity |RC| of passenger combinations and a quantity |V| of drivers, namely |VRC|=min {|RC|, |V|}, and the travel path and travel time of each driver-passenger combination is recorded.

The above-mentioned method achieves passenger-vehicle matching, and the system cloud end server sends the matching result and travel path to the mobile phone App of the driver and passenger respectively in the form of an order. After receiving the order, the driver travels according to the travel path given by the order, and sequentially receives and sends each passenger. The user waits on the spot to get on the vehicle, and pays a certain fee to the driver according to the price calculated by App after arriving at the destination to get off the vehicle. When the last passenger gets out of the vehicle and the payment is completed, the present Internet contract shared travel is completed.

### BRIEF DESCRIPTION OF THE DRAWINGS

FIG. 1 is a flow diagram of a method of the present disclosure;

FIG. 2 is a flow diagram of passenger combination matching under a “two-person pooling” demand;

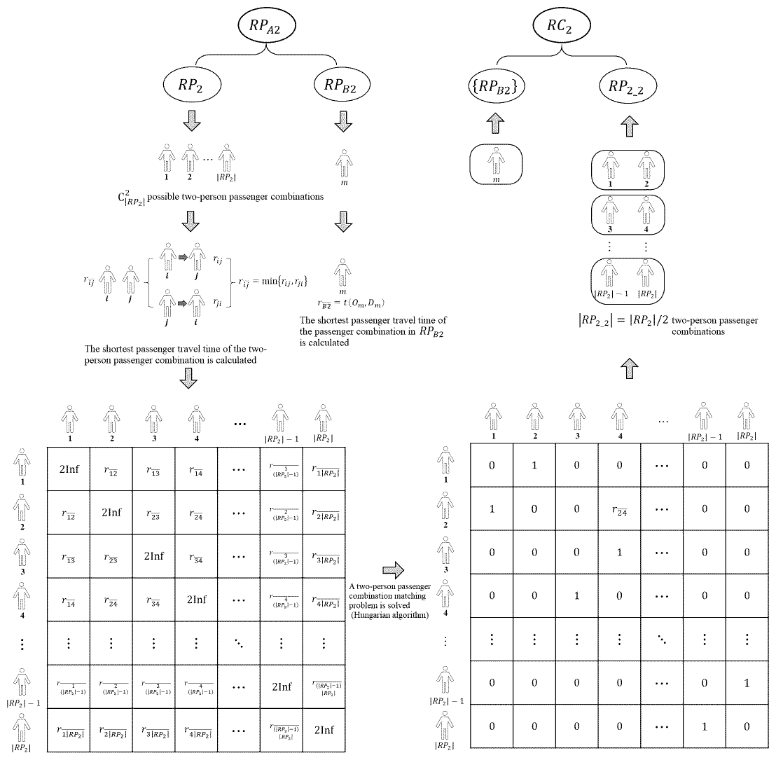

FIG. 3 is a flow diagram of passenger combination matching under a “three-person pooling” demand.

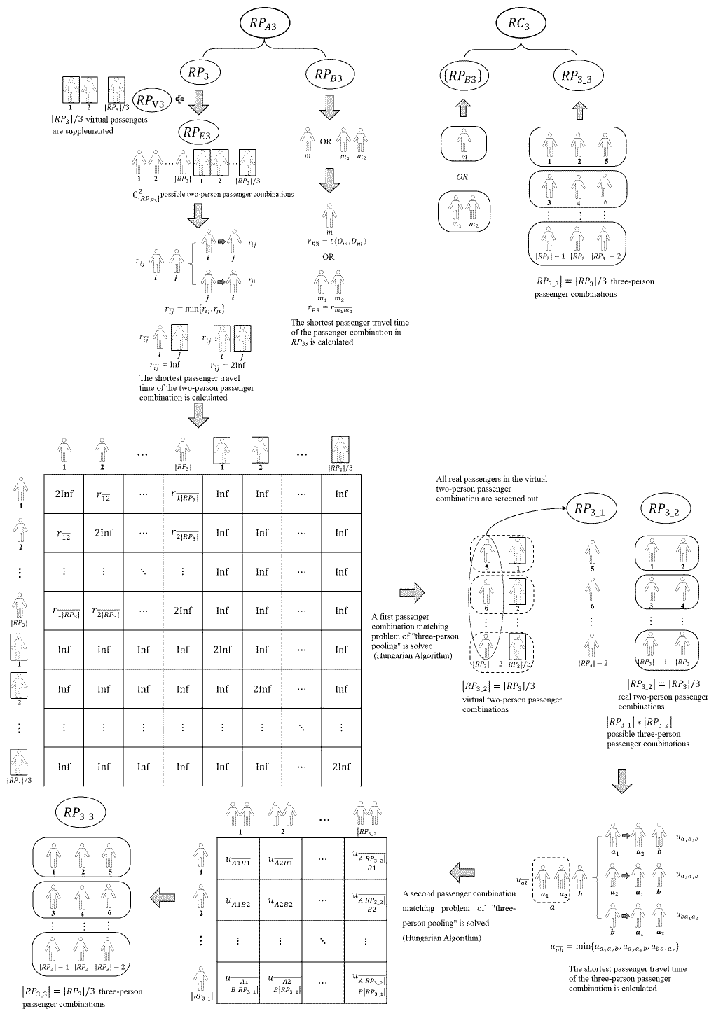

### DETAILED DESCRIPTION OF THE INVENTION

The disclosure will now be further described by way of embodiments and with reference to the accompanying drawings.

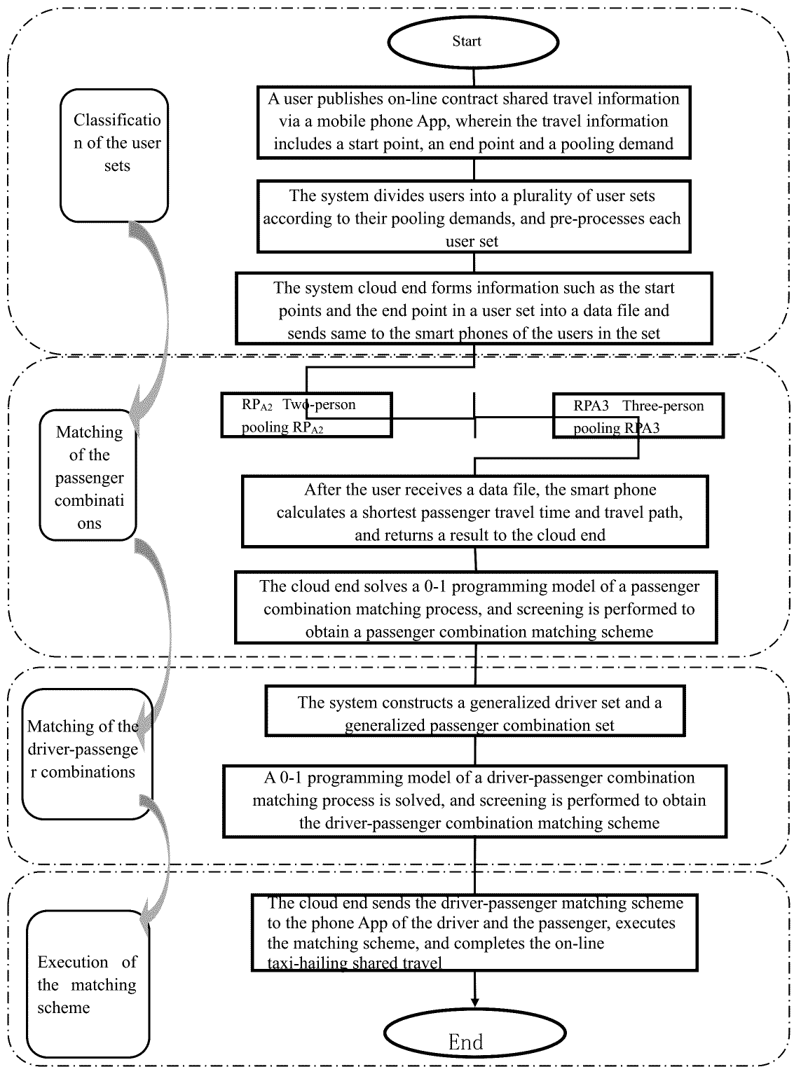

The present disclosure provides a passenger-vehicle matching method for on line ride-sharing service, as shown in FIG. 1, including the following processes:

I. A user publishes on-line contract shared travel information via a mobile phone App, wherein the travel information includes a start point, an end point and a pooling demand; the system divides users into a plurality of user sets according to their pooling demands, and pre-processes each user set. The system cloud end server forms information such as the start points and the end point in a user set into a data file and sends same to the smart phones of the users in the set.

The cloud end of the system stores real-time travel data of the points of getting on and off the Internet contract shared travel within the city. At a certain moment, 26 users in the system publish the shared travel demand through the mobile phone App, and the quantity of users with the pooling demand of “two-person pooling” and “three-person pooling” is each RP_{A2} 13, respectively forming sets RP_{A2} and RP_{A3}. The information for each user set is shown in Table 1.

TABLE 1
Individual passenger set Information

| | | | | | |
|---|---|---|---|---|---|
| User serial | User start | User end | User serial | User start | User end |
| number | point | point | number | point | point |

User set RP_{A2} with the “two-person pooling” demand

| | | | | | |
|---|---|---|---|---|---|
| 1 | 406 | 260 | 8 | 199 | 445 |
| 2 | 391 | 432 | 9 | 464 | 99 |
| 3 | 118 | 146 | 10 | 175 | 483 |
| 4 | 315 | 400 | 11 | 341 | 387 |
| 5 | 154 | 490 | 12 | 107 | 342 |
| 6 | 424 | 290 | 13 | 58 | 162 |
| 7 | 433 | 391 | | | |

User set RP_{A3}
with the “three-person pooling” demand

| | | | | | |
|---|---|---|---|---|---|
| 1 | 492 | 116 | 8 | 441 | 88 |
| 2 | 233 | 210 | 9 | 368 | 486 |
| 3 | 168 | 61 | 10 | 100 | 459 |
| 4 | 104 | 112 | 11 | 235 | 388 |
| 5 | 96 | 56 | 12 | 51 | 374 |
| 6 | 64 | 95 | 13 | 180 | 245 |
| 7 | 383 | 20 | | | |

### Readily Available:

$$\begin{matrix}\vert {RP}_{A 2} \vert = 13 , \vert {RP}_{B 2} \vert = \vert {RP}_{A 2} \vert \%2 = 1 \\ \vert {RP}_{A 3} \vert = 13 , \vert {RP}_{B 3} \vert = \vert {RP}_{A 3} \vert \%2 = 1\end{matrix}$$

Since |RP_{B2}|, |RP_{B3}|, and |RP_{B4}| are neither 0, the passengers are selected to cope with this possibility, the system will process the passenger set in advance: two-person pooling: a set RP_{B2} is constituted by randomly selecting |RP_{B2}|=1 users within the set RP_{A2}. Finally, the user of number 13 selecting “two-person pooling”, the “secondary user set 2” RP_{B2}={13}, and the remaining users constitute “primary user set 2” RP₂.

Three-person pooling: a set RP_{B3} is constituted by randomly selecting |RP_{B3}|=1 passengers within the set RP_{A3}. Finally, the user of number 10 selecting “three-person pooling”, the “secondary user set 3” RP_{B3}={10}, and the remaining users constitute “primary user set 3” RP₃.

After receiving the on-line contract shared travel information about the user and completing user set classification and pre-processing, the cloud end respectively aggregates the travel start points and the travel end points of the users in the sets RP₂ and RP₃, and extracts travel times between these nodes to form three data files: File2 and File3.

After forming the data file, the cloud end sends the data file File2 to the smart phones of all the users in the set RP₂, and sends the data file File3 to the smart phones of all the users in the set RP₃.

II, the passenger combination is matched within the user sets RP_{A2} and RP_{A3} with “two-person pooling” and “three-person pooling” demands. Firstly, the user receives the data file, calculates the shortest passenger travel time and travel path of a two-person passenger combination when the current user is the first passenger, and returns the result to the cloud end; secondly, the system cloud end server receives the results, solves the 0-1 programming model of passenger combination matching process, and obtains the passenger combination matching scheme.

### 1. Two-Person Pooling

1) The current passenger is taken as the first passenger, and the shortest passenger travel time and path of two-person passenger combination are calculated.

The smart phone of the user i∈RP₂ receives the data file File2 sent by the cloud end. After receiving the File2, the smart phone of the user i takes the user i as the first passenger, calculates the shortest travel path and travel time of the two-person passenger combination formed by the user i and another user j∈RP₂\{i}, and returns the calculation result to the system cloud end server. A calculation formula is as follows:

$${P}_{i j} = \{ {O}_{i} \to {O}_{j} \to {D}_{i} \to {D}_{j} , {O}_{i} \to {O}_{j} \to {D}_{j} \to {D}_{i} \}$$

$${r}_{i j} = min \{ t ( {O}_{i} , {O}_{j} ) + t ( {O}_{j} , {D}_{i} ) + t ( {D}_{i} , {D}_{j} ) , t ( {O}_{i} , {O}_{j} ) + t ( {O}_{j} , {D}_{j} ) + t ( {D}_{j} , {D}_{i} ) \}$$

as stated above, “taking the user i as the first passenger” means taking the start point Oᵢ of the user i as a jumping-off place, so that the user i is the passenger gets aboard at first. In order to achieve the user's “two-person pooling” demand, the driver needs to first pick up the two passengers i and j and then send them to destinations respectively. In the formula, for Oᵢ→Oⱼ→Dᵢ→Dⱼ and Oᵢ→Oⱼ→Dⱼ→Dᵢ, all the paths are represented by nodes which are passed through in sequence, which are all the possible travel paths of the two-person passenger combination {i, j} when the user i is the first passenger. Pᵢⱼ represents a travel path set of the two-person passenger combination {i, j} when the user i is the first passenger, t(Ou, Oⱼ), t(Oⱼ, Dᵢ), t(Dᵢ, Dⱼ), t(Oⱼ, Dⱼ), and t(Dᵢ, Dⱼ) represent travel times between two nodes in parentheses; t(Oᵢ, Oⱼ)+t(Oⱼ, Dᵢ)+t(Dᵢ, Dⱼ) and t(Oᵢ, Oⱼ)+t(Oⱼ, Dⱼ)+t(Dⱼ, Dᵢ) each indicate the possible travel time of the two-person passenger combination {i, j} when the user i is the first passenger. rᵢⱼ represents the shortest passenger travel time of the two-person passenger combination {i, j} when the user i is the first passenger. a quantity of users in RP₂ is |RP₂|, then the user i∈RP₂ forms (|RP₂|−1) two-person passenger combinations with other users, and the smart phone of the user i E RP₂ needs to perform no less than (|RP₂|−1) times of calculations.

2) The system compares the shortest passenger travel times when different users in respective two-person passenger combinations serve as the first passenger, and determines the shortest passenger travel time and travel path of each two-person passenger combination.

Within the two-person passenger combination {i, j}, a sum of the shortest passenger travel times rᵢⱼ and rⱼᵢ with the user i and the user j as the first passenger are compared with each other, the shortest passenger travel time r_{i̅j̅} of the two-person passenger combination is determined, and a travel path corresponding to r_{i̅j̅} is recorded. A formula is as follows:

$${r}_{\overline{i j}} = min \{ {r}_{ij} , {r}_{j i} \}$$

since

$$\frac{\vert {RP}_{2} \vert ( \vert {RP}_{2} \vert - 1 )}{2}$$

possible two-person passenger combinations can be formed within the “main user set 2” RP₂, the system cloud end server needs to perform no less than

$$\frac{\vert {RP}_{2} \vert ( \vert {RP}_{2} \vert - 1 )}{2}$$

times of comparisons.

Under the premise of existence of the “user j∈RP₂ \{i}” in the two-person passenger combination {i, j}, there are parameters r_{i̅i̅} and variables xᵢᵢ about the two-person passenger combination {i, i} in the following 0-1 programming model. For this purpose, if the Inf=99999 in the system is set, then:

$${r}_{\overline{i i}} = Inf , ∀ i ∈ R {P}_{2}$$

after calculation, the shortest passenger travel time of the two-person passenger combination is:

TABLE 2
Shortest passenger travel time for the two-person passenger combination (“two-person pooling”)

| | Passenger | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| 1 | 99999 | 106.05 | 103.84 | 140.68 | 116.25 | 62.37 | 142.9 | 85.85 | 144.13 | 87.19 | 37.81 | 76.11 |
| 2 | 106.05 | 99999 | 120.57 | 60.25 | 148.12 | 103.38 | 103.89 | 85.8 | 145.68 | 144.13 | 134.09 | 148.46 |
| 3 | 103.84 | 120.57 | 99999 | 73.52 | 145.25 | 49.8 | 89.33 | 62.29 | 85.54 | 66.53 | 122.09 | 55.21 |
| 4 | 140.68 | 60.25 | 73.52 | 99999 | 61.47 | 151.2 | 34.27 | 163.49 | 126.34 | 99.3 | 155.53 | 87.69 |
| 5 | 116.25 | 148.12 | 145.25 | 61.47 | 99999 | 113.95 | 87.29 | 107.52 | 145.97 | 13.02 | 161.96 | 92.79 |
| 6 | 62.37 | 103.38 | 49.8 | 151.2 | 113.95 | 99999 | 141.34 | 164.79 | 86.2 | 78.57 | 58.82 | 88.05 |
| 7 | 142.9 | 103.89 | 89.33 | 34.27 | 87.29 | 141.34 | 99999 | 114.34 | 91.81 | 118.84 | 37.94 | 81.86 |
| 8 | 85.85 | 85.8 | 62.29 | 163.49 | 107.52 | 164.79 | 114.34 | 99999 | 116.99 | 71.87 | 74.28 | 152.58 |
| 9 | 144.13 | 145.68 | 85.54 | 126.34 | 145.97 | 86.2 | 91.81 | 116.99 | 99999 | 56.97 | 134.55 | 86 |
| 10 | 87.19 | 144.13 | 66.53 | 99.3 | 13.02 | 78.57 | 118.84 | 71.87 | 56.97 | 99999 | 86.51 | 134.4 |
| 11 | 37.81 | 134.09 | 122.09 | 155.53 | 161.96 | 58.82 | 37.94 | 74.28 | 134.55 | 86.51 | 99999 | 28.1 |
| 12 | 76.11 | 148.46 | 55.21 | 87.69 | 92.79 | 88.05 | 81.86 | 152.58 | 86 | 134.4 | 28.15 | 99999 |

3) all the users within the set RP_{B2} are formed into a passenger combination RP_{C2}, and the shortest passenger travel time [symbol] and travel path of the passenger combination are calculated.

Under the user's “two-person pooling” demand, due to |RP_{B2}|=1, RP_{B2}={13}; all users in the set RP_{B2} are formed into one passenger combination represented by RP_{C2}, i.e. RP_{C2}={13}, then [symbol] =t(Oₘ, Dₘ)=t(58, 162)=55.896, and the path is 58→162. {RP_{C2}} is allowed to represent the passenger combination set formed by the passenger combinations RP_{C2}.

4) A matching problem of the two-person passenger combination is solved, and a two-person pooling passenger matching scheme with an optimal total passenger travel time is obtained.

For any user i∈RP₂, he can only form a two-person passenger combination with another user j∈RP₂\{i} ultimately. With a goal of minimizing the total passenger travel time, while under the user's “two-person pooling demand”, the matching problem of the two-person passenger combination can be transformed into a 0-1 programming model as follows:

$$min {\sum }_{i = 1}^{\vert {RP}_{2} \vert} {\sum }_{j = 1}^{\vert {RP}_{2} \vert} {r}_{\overline{i j}} {x}_{i j}$$

$$s . t . \{ \begin{matrix}{\sum }_{i = 1}^{\vert {RP}_{2} \vert} {x}_{ij} = 1 , ∀ j ∈ {RP}_{2} \\ {\sum }_{j = 1}^{\vert {RP}_{2} \vert} {x}_{ij} = 1 , ∀ i ∈ {RP}_{2} \\ {x}_{ij} = 0 or 1 , ∀ i , j ∈ {RP}_{2}\end{matrix}$$

where xᵢⱼ is a 0-1 variable: in a solution result of the model, if the user i and the user j constitute a two-person passenger combination {i, j}, then xᵢⱼ=1, otherwise xᵢⱼ=0.

Since there is no constraint i≠j in the 0-1 programming model, there is a repeated two-person passenger combination {i, i} and relevant parameter r_{i̅i̅} and variable xᵢᵢ in the model, but it is impossible for a user i to form the two-person passenger combination with himself in practice, and in order to enable the 0-1 programming model to solve the two-person pooling passenger matching process, the shortest passenger travel time r_{i̅i̅} for the repeated two-person passenger combination {i, i} is set as follows:

$${r}_{\overline{i i}} = Inf , ∀ i ∈ R {P}_{2}$$

in the formula, Inf represents a positive infinite constant.

Hungarian algorithm is used to solve the 0-1 programming model, and an obtained solution vector is x=(xᵢⱼ, i∈RP₂, j∈RP₂)^{T}, the two-person passenger combination corresponding to xᵢⱼ=1 is screened out, the passenger combination set RP_{2_2} is formed, which is referred to as the main passenger combination set 2, a quantity of set elements of which is RP_{2_2}=|RP₂|/2.

The set RC₂=RP_{2_2}∪{RP_{C2}} is allowed to represent the passenger combination set formed by the users of the two-person pooling demand, i.e. a union set of RP_{2_2} and {RP_{C2}}. The travel path and travel time of each passenger combination in the set RC₂ are recorded, and a quantity |RC₂| of set elements represents a quantity of the passenger combinations under the two-person pooling demand.

The travel paths and travel times for the passenger combinations in Table 3.

TABLE 3
Passenger matching results of “two-person pooling”

| Passenger | | Travel | |
|---|---|---|---|
| combination | Travel path | time | Set |
| {1, 11} | 341 → 406 → 387 → 260 | 37.812 | RP₂_2 |
| {2, 8} | 391 → 199 → 432 → 445 | 85.797 | |
| {3, 6} | 424 → 118 → 146 → 290 | 49.798 | |
| {4, 7} | 433 → 315 → 400 → 391 | 34.272 | |
| {5, 10} | 154 → 175 → 490 → 483 | 13.016 | |
| {9, 12} | 107 → 464 → 342 → 99 | 85.998 | |
| {13} | 58 → 162 | 55.896 | RP_{B2} |

### 2. Three-Person Pooling

1) The system cloud end server pre-supplements a certain quantity of virtual users on the basis of RP₃ to form a generalized user set RP_{E3}; the user in RP₃ calculates the shortest passenger travel time and travel path of all possible two-person passenger combinations with himself as the first passenger, and returns a calculation result to the system cloud end server;

A quantity |RP₃|/3 of virtual users are pre-supplemented before passenger combination matching under the three-person pooling demand of the user, and the travel start points Oᵢ and the travel end points Dᵢ of the virtual users are all virtual nodes; the virtual node does not exist in a real urban road network, and the distance to any real node is positively infinite. |RP₃|/3 virtual users constitute a virtual user set RP_{V3}, and a union set of the virtual user set RP_{V3} and RP₃ is the generalized user set RP_{E3}, namely RP_{E3}=RP₃∪RP_{V3}, Inf representing a positive infinite constant.

The smart phone of the user i∈RP₃ receives the data file File3 sent by the cloud end. After receiving the File3, the smart phone of the user i takes the user i as the first passenger, calculates the shortest travel path and travel time of the two-person passenger combination formed by the user i and another user j∈RP₃ \{i}, and returns the calculation result to the system cloud end server. A calculation formula is as follows:

$${P}_{i j} = \{ {O}_{i} \to {O}_{j} \to {D}_{i} \to {D}_{j} , {O}_{i} \to {O}_{j} \to {D}_{j} \to {D}_{i} \}$$

$${r}_{i j} = min \{ t ( {O}_{i} , {O}_{j} ) + t ( {O}_{j} , {D}_{i} ) + t ( {D}_{i} , {D}_{j} ) , t ( {O}_{i} , {O}_{j} ) + t ( {O}_{j} , {D}_{j} ) + t ( {D}_{j} , {D}_{i} ) \}$$

as stated above, taking the user i as the first passenger means taking the start point Oᵢ of the user i as a jumping-off place, so that the user i is the passenger gets aboard at first, and the driver firstly receives the users i and j as the two passengers, and then send them to destinations respectively. In the formula, in both Oᵢ-Oⱼ→Dᵢ→Dⱼ and Oᵢ→Oⱼ→Dⱼ→Dᵢ, paths are represented by nodes which are passed through successively, and all possible travel paths of the two-person passenger combination {i, j} are taken when the user i is the first passenger, and Pᵢⱼ represents a travel path set of the two-person passenger combination {i, j} when the user i is the first passenger, and t(Oᵢ, Oⱼ), t(Oⱼ, Dᵢ), t(Dᵢ, Dⱼ), t(Oⱼ, Dⱼ), and t(Dᵢ, Dⱼ) all represent travel time between two nodes in parentheses, t(Oᵢ, Oⱼ)+t(Oⱼ, Dᵢ)+t(Dᵢ, Dⱼ) and t(Oᵢ, Oⱼ)+t(Oⱼ, Dⱼ)+t(Dⱼ, Dᵢ) both represent possible travel time of the two-person passenger combination {i, j} when the user i is the first passenger, and rᵢⱼ represents a shortest passenger travel time of the two-person passenger combination {i, j} when the user {i, j} is the first passenger.

A quantity of users in RP₃ is |RP₃|, then the user i∈RP₃ forms (|RP₃|−1) two-person passenger combinations with other users, and the smart phone of the user i∈RP₃ needs to perform no less than (|RP₃|−1) times of calculations.

2) The system cloud end server compares the shortest passenger travel times when different users in respective two-person passenger combinations serve as the first passenger, and determines the shortest passenger travel time and travel path of each two-person passenger combination.

Within the two-person passenger combination {i, j}, a sum of the shortest passenger travel times rᵢⱼ and rⱼᵢ with the user i and the user j as the first passenger are compared with each other, the shortest passenger travel time r_{i̅j̅} of the two-person passenger combination is determined, and a travel path corresponding to r_{i̅j̅} is recorded. A formula is as follows:

$${r}_{\overline{i j}} = min \{ {r}_{ij} , {r}_{j i} \}$$

since

$$\frac{\vert {RP}_{3} \vert ( \vert {RP}_{3} \vert - 1 )}{2}$$

possible two-person passenger combinations can be formed within the “main user set 3” RP₃, the system cloud end server needs to perform no less than

$$\frac{\vert {RP}_{3} \vert ( \vert {RP}_{3} \vert - 1 )}{2}$$

times of comparisons.

Real users and virtual users are collectively referred to as generalized users. If the passengers i and j in the two-person passenger combination {i, j} are both real users, then {i, j} is taken as the real two-person passenger combination; if the passenger i in the two-person passenger combination {i, j} is a real user and the passenger j is a virtual user, or if the passenger i is a virtual user and the passenger j is a real user, then {i, j} is taken as the mixed two-person passenger combination; if the passengers i and j in the two-person passenger combination {i, j} are both virtual users, then {i, j} is taken as a virtual two-person passenger combination. The real two-person passenger combination, the mixed two-person passenger combination and the virtual two-person passenger combination are collectively referred to as the generalized two-person passenger combination.

The generalized two-person passenger combination {i, j} also has the premise of “generalized user j∈RP_{E3} \{i}”, but it is not constrained to i≠j in the 0-1 programming model. The 0-1 programming model not only has the repeated two-person passenger combination {i, i} and the related parameter r_{i̅i̅} and variable xᵢᵢ, but also has the virtual user and the mixed two-person passenger combination and the virtual two-person passenger combination which may be formed.

In order to make it possible for the subsequent 0-1 programming model to solve the first passenger matching process of “three-person pooling”, the shortest passenger travel time of any generalized two-person passenger combination {i, j} is set as follows:
if i∈RP₃, j∈RP₃ and i≠j, it is the real two-person passenger combination, and the shortest passenger travel time thereof is [symbol] ;
if i∈RP₃, j∈RP_{V3} or j∈RP₃, i∈RP_{V3}, it is the mixed two-person passenger combination, and the shortest passenger travel time thereof is Inf;
if i∈RP_{V3}, j∈RP_{V3} and i≠j, it is the virtual two-person passenger combination, and the shortest passenger travel time thereof is 2*Inf.

For the repeated two-person passenger combination {i, i}, the shortest passenger time [symbol] thereof is set as 2*Inf.

The shortest passenger travel time for the generalized two-person passenger combination at this time is shown in Table 4:

TABLE 4
Shortest passenger travel time for generalized two-person
passenger combination (“three-person pooling”)

| | Passenger | | | | | | | |
|---|---|---|---|---|---|---|---|---|
| | 1 | 2 | 3 | 4 | 5 | 6 | 7 | 8 |
| 1 | 199998 | 95.33 | 50.79 | 63.36 | 176.58 | 77.01 | 111.74 | 72.42 |
| 2 | 95.33 | 199998 | 166.02 | 70.35 | 43.02 | 106.74 | 115.14 | 115.67 |
| 3 | 50.79 | 166.02 | 199998 | 80.12 | 90.06 | 11468 | 86.2 | 83.18 |
| 4 | 63.36 | 70.35 | 80.12 | 199998 | 61.75 | 152.43 | 93.54 | 76.63 |
| 5 | 176.58 | 43.02 | 90.06 | 61.75 | 199998 | 102.6 | 86.61 | 128.21 |
| 6 | 77.01 | 106.74 | 114.68 | 152.43 | 102.6 | 199998 | 82.98 | 99.07 |
| 7 | 111.74 | 115.14 | 86.2 | 93.54 | 86.61 | 82.98 | 199998 | 72.43 |
| 8 | 72.42 | 115.67 | 83.18 | 76.63 | 128.21 | 99.07 | 72.43 | 199998 |
| 9 | 131.46 | 86.08 | 100.43 | 56.15 | 111.79 | 100.71 | 133.4 | 127.1 |
| 11 | 81.52 | 195.25 | 96.57 | 129.31 | 109.67 | 172 | 123.09 | 84.24 |
| 12 | 153.13 | 143.74 | 146.66 | 107.12 | 100.78 | 69.31 | 91.67 | 191.82 |
| 13 | 184.93 | 97.66 | 164.49 | 84.95 | 107.49 | 101.52 | 75.61 | 34.74 |
| −1 | 99999 | 99999 | 99999 | 99999 | 99999 | 99999 | 99999 | 99999 |
| −2 | 99999 | 99999 | 99999 | 99999 | 99999 | 99999 | 99999 | 99999 |
| −3 | 99999 | 99999 | 99999 | 99999 | 99999 | 99999 | 99999 | 99999 |
| −4 | 99999 | 99999 | 99999 | 99999 | 99999 | 99999 | 99999 | 99999 |

| | Passenger | | | | | | | |
|---|---|---|---|---|---|---|---|---|
| | 9 | 11 | 12 | 13 | −1 | −2 | −3 | −4 |
| 1 | 131.46 | 81.52 | 153.13 | 18493 | 99999 | 99999 | 99999 | 99999 |
| 2 | 86.08 | 195.25 | 143.74 | 97.66 | 99999 | 99999 | 99999 | 99999 |
| 3 | 100.43 | 96.57 | 146.66 | 164.49 | 99999 | 99999 | 99999 | 99999 |
| 4 | 56.15 | 12931 | 107.12 | 84.95 | 99999 | 99999 | 99999 | 99999 |
| 5 | 111.79 | 109.67 | 100.78 | 107.49 | 99999 | 99999 | 99999 | 99999 |
| 6 | 100.71 | 172 | 69.31 | 101.52 | 99999 | 99999 | 99999 | 99999 |
| 7 | 133.4 | 123.09 | 91.67 | 75.6 | 99999 | 99999 | 99999 | 99999 |
| 8 | 127.1 | 84.24 | 191.82 | 34.74 | 99999 | 99999 | 99999 | 99999 |
| 9 | 199998 | 123.16 | 117.4 | 99.99 | 99999 | 99999 | 99999 | 99999 |
| 11 | 123.16 | 199998 | 144.75 | 73.82 | 99999 | 99999 | 99999 | 99999 |
| 12 | 117.4 | 144.75 | 199998 | 115.13 | 99999 | 99999 | 99999 | 99999 |
| 13 | 99.99 | 73.82 | 115.13 | 199998 | 99999 | 99999 | 99999 | 99999 |
| −1 | 99999 | 99999 | 99999 | 99999 | 199998 | 199998 | 199998 | 199998 |
| −2 | 99999 | 99999 | 99999 | 99999 | 199998 | 199998 | 199998 | 199998 |
| −3 | 99999 | 99999 | 99999 | 99999 | 199998 | 199998 | 199998 | 199998 |
| −4 | 99999 | 99999 | 99999 | 99999 | 199998 | 199998 | 199998 | 199998 |

The passengers with negative numbers in Table 4 are all virtual passengers.

3) All the users within “secondary user set 3” RP_{B3} are formed into a passenger combination RP_{C3}, and the shortest passenger travel time r_{C̅3̅} and travel path of the passenger combination are calculated.

Under the user's “three-person pooling” demand, due to |RP_{B3}|=1, RP_{B3}={10}; all users in the set RP_{B3} are formed into one passenger combination represented by RP_{C3}, that is a “secondary passenger combination 3” RP_{C3}={10}, then [symbol] =t(Oₘ, Dₘ)=t(100,459)=69.585, and the path is 100→459. {RP_{C3}} is allowed to represent the passenger combination set formed by the passenger combinations RP_{C3}, referred to as a “secondary passenger combination set 3”.

4) To solve a first passenger combination matching problem under the “three-person pooling” demand of the user, |RP_{E3}|/2 generalized two-person passenger combinations is matched in the generalized user set RP_{E3}, and then real users in |RP₃|/2 real two-person passenger combinations and |RP₃|/2 mixed two-person passenger combinations are selected out.

The first passenger combination matching process under the of “three-person pooling” demand needs to match |RP_{E3}|/2 generalized two-person passenger combinations in the generalized user set RP_{E3}. For any generalized user i∈RP_{E3}, he can only form a generalized two-person passenger combination with another generalized user j∈RP_{E3} \{i} ultimately. With a goal of minimizing the total passenger travel time, the matching problem of the generalized two-person passenger combination can be transformed into a 0-1 programming model as follows:

$$min {\sum }_{i} {\sum }_{j} {r}_{\overline{i j}} {x}_{i j}$$

$$s . t . \{ \begin{matrix}{\sum }_{i} {x}_{ij} = 1 , ∀ j ∈ {RP}_{E 3} \\ {\sum }_{j} {x}_{ij} = 1 , ∀ i ∈ {RP}_{E 3} \\ {x}_{ij} = 0 or 1 , ∀ i , j ∈ {RP}_{E 3}\end{matrix}$$

where xᵢⱼ is a variable from 0 to 1; in a model solution result, if the generalized user i and the generalized user j constitute the generalized two-person passenger combination {i, j}, then xᵢⱼ=1, otherwise xᵢⱼ=0.

The Hungarian algorithm is applied to solve the 0-1 programming model, and the solved vector is x=(xᵢⱼ, i∈RP_{E3}, j∈RP_{E3})^{T}, 2*(|RP₃|/3) generalized two-person passenger combinations corresponding to xᵢⱼ=1 are screened out, wherein there are |RP₃|/3 real two-person passenger combinations and |RP₃|/3 mixed two-person passenger combinations.

The |RP₃|/3 real two-person passenger combinations are screened out to construct the real two-person passenger combination set RP_{3_2} and the quantity of set elements is |RP_{3_2}|=|RP₃|/3=4.

Then the real users in |RP₃|/3=4 mixed two-person passenger combinations are screened out to construct the user set RP_{3_1} and the quantity of set elements is |RP_{3_1}|=|RP₃|/3=4.

The sets RP_{3_2} and RP_{3_1} resulting from the processing are respectively:

$$\begin{matrix}R {P}_{3 \_ 2} = \{ \{ 1 , 3 \} , \{ 2 , 5 \} , \{ 4 , 9 \} , \{ 8 , 13 \} \} \\ {RP}_{3 \_ 1} = \{ 6 , 7 , 11 , 12 \}\end{matrix}$$

after the system cloud end server completes the first passenger combination matching of the “three-person pooling”, the start points and the end points of two users of each real two-person passenger combination in the set RP_{3_2} are extracted to form a data file File3_2; start points and end points of each user in the set RP_{3_1} are extracted to form a data file File3_1. After forming the data files, the system cloud sends the data files File3-1 and File3-2 to all the smart phones of the users in the set RP₃ again.

5) The current passenger is taken as the first passenger, and the shortest passenger travel time and travel path of the three-person passenger combination are calculated.

The first pass passenger combination matching process of “three-person pooling” can obtain a real two-person passenger combination set RP_{3_2} and a user set RP_{3_1}. A real two-person passenger combination {i, j}∈RP_{3_2} and a real user k E RP_{3_1}, then the user i, the user j and the user k can constitute a three-person passenger combination {i, j, k}.

A step of calculating the shortest passenger travel time of the three-person passenger combination {i, j, k} is as follows:

Smart phones of the user i, j∈{i, j}, {i, j}∈RP_{3_2} and the user k∈RP_{3_1} receive data files File3_1 and File3_2 sent by the cloud end.

After receiving the files File3_1 and File3_2, the smart phone of the user i calculates the shortest travel path and travel time of the three-person passenger combination formed by the user i, the user j and the user k with the user i as the first passenger. The calculation results are returned to the system cloud end server. A calculation formula is as follows:

$${P}_{ijk} = \{ \begin{matrix}{O}_{i} \to {O}_{j} \to {O}_{k} \to {D}_{i} \to {D}_{j} \to {D}_{k} , \\ {O}_{i} \to {O}_{k} \to {O}_{j} \to {D}_{i} \to {D}_{j} \to {D}_{k} , \\ {O}_{i} \to {O}_{j} \to {O}_{k} \to {D}_{i} \to {D}_{k} \to {D}_{j} , \\ {O}_{i} \to {O}_{k} \to {O}_{j} \to {D}_{i} \to {D}_{k} \to {D}_{j} , \\ {O}_{i} \to {O}_{j} \to {O}_{k} \to {D}_{j} \to {D}_{i} \to {D}_{k} , \\ {O}_{i} \to {O}_{k} \to {O}_{j} \to {D}_{j} \to {D}_{i} \to {D}_{k} , \\ {O}_{i} \to {O}_{j} \to {O}_{k} \to {D}_{j} \to {D}_{k} \to {D}_{i} , \\ {O}_{i} \to {O}_{k} \to {O}_{j} \to {D}_{j} \to {D}_{k} \to {D}_{i} , \\ {O}_{i} \to {O}_{j} \to {O}_{k} \to {D}_{k} \to {D}_{i} \to {D}_{j} , \\ {O}_{i} \to {O}_{k} \to {O}_{j} \to {D}_{k} \to {D}_{i} \to {D}_{j} , \\ {O}_{i} \to {O}_{j} \to {O}_{k} \to {D}_{k} \to {D}_{j} \to {D}_{i} , \\ {O}_{i} \to {O}_{k} \to {O}_{j} \to {D}_{k} \to {D}_{j} \to {D}_{i} ,\end{matrix} \}$$

$${r}_{ijk} = min \{ \begin{matrix}t ( {O}_{i} , {O}_{j} ) + t ( {O}_{j} , {O}_{k} ) + t ( {O}_{k} , {D}_{i} ) + t ( {D}_{i} , {D}_{j} ) + t ( {D}_{j} , {D}_{k} ) , \\ t ( {O}_{i} , {O}_{k} ) + t ( {O}_{k} , {O}_{j} ) + t ( {O}_{j} , {D}_{i} ) + t ( {D}_{i} , {D}_{j} ) + t ( {D}_{j} , {D}_{k} ) , \\ t ( {O}_{i} , {O}_{j} ) + t ( {O}_{j} , {O}_{k} ) + t ( {O}_{k} , {D}_{i} ) + t ( {D}_{i} , {D}_{k} ) + ( {D}_{k} , {D}_{j} ) , \\ t ( {O}_{i} , {O}_{k} ) + t ( {O}_{k} , {O}_{j} ) + t ( {O}_{j} , {D}_{i} ) + t ( {D}_{i} , {D}_{k} ) + t ( {D}_{k} , {D}_{j} ) , \\ t ( {O}_{i} , {O}_{j} ) + t ( {O}_{j} , {O}_{k} ) + t ( {O}_{k} , {D}_{j} ) + t ( {D}_{j} , {D}_{i} ) + t ( {D}_{i} , {D}_{k} ) , \\ t ( {O}_{i} , {O}_{k} ) + t ( {O}_{k} , {O}_{j} ) + t ( {O}_{j} , {D}_{j} ) + t ( {D}_{j} , {D}_{i} ) + t ( {D}_{i} , {D}_{k} ) , \\ t ( {O}_{i} , {O}_{j} ) + t ( {O}_{j} , {O}_{k} ) + t ( {O}_{k} , {D}_{j} ) + t ( {D}_{j} , {D}_{k} ) + t ( {D}_{k} , {D}_{i} ) , \\ t ( {O}_{i} , {O}_{k} ) + t ( {O}_{k} , {O}_{j} ) + t ( {O}_{j} , {D}_{j} ) + t ( {D}_{j} , {D}_{k} ) + t ( {D}_{k} , {D}_{i} ) , \\ t ( {O}_{i} , {O}_{j} ) + t ( {O}_{j} , {O}_{k} ) + t ( {O}_{k} , {D}_{k} ) + t ( {D}_{k} , {D}_{i} ) + t ( {D}_{i} , {D}_{j} ) , \\ t ( {O}_{i} , {O}_{k} ) + t ( {O}_{k} , {O}_{j} ) + t ( {O}_{j} , {D}_{k} ) + t ( {D}_{k} , {D}_{i} ) + t ( {D}_{i} , {D}_{j} ) , \\ t ( {O}_{i} , {O}_{j} ) + t ( {O}_{j} , {O}_{k} ) + t ( {O}_{k} , {D}_{k} ) + t ( {D}_{k} , {D}_{j} ) + t ( {D}_{j} , {D}_{i} ) , \\ t ( {O}_{i} , {O}_{k} ) + t ( {O}_{k} , {O}_{j} ) + t ( {O}_{j} , {D}_{k} ) + t ( {D}_{k} , {D}_{j} ) + t ( {D}_{j} , {D}_{i} )\end{matrix} \}$$

as described above, in order to achieve the “three-person pooling” demand of the user, the driver needs to pick up three passengers and then send them to the destinations respectively. In the formula, Pᵢⱼₖ represents a travel path set of the three-person passenger combination {i, j, k} when the user i is the first passenger; the elements Oⱼ→Oᵢ→Oₖ→Dᵢ→Dⱼ→Dₖ therein are all paths, which are represented by nodes that are passed through in sequence. rᵢⱼₖ represents the shortest passenger travel time of the three-person passenger combination {i, j, k} when the user i is the first passenger; the elements such as t(Oₖ, Oⱼ)+t(Oⱼ, Oᵢ)+t(Oᵢ, Dᵢ)+t(Dᵢ, Dⱼ)+t(Dⱼ, Dₖ) all represent possible travel times for the three-person passenger combination {i, j, k}.

6) The system cloud end server compares the shortest passenger travel times when different users in respective three-person passenger combinations serve as the first passenger, and determines the shortest passenger travel time and travel path of each three-person passenger combination.

Within the three-person passenger combination {i, j, k}, the system compares the shortest passenger travel times rᵢⱼₖ, rⱼᵢₖ, and rₖᵢⱼ of the user i, the user j, and the user k as the first passenger, determines the shortest passenger travel time r_{j̅i̅k̅} of the three-person passenger combination, and records a travel path corresponding to [symbol] . A formula is as follows:

$${r}_{\overline{ijk}} = min \{ {r}_{ijk} , {r}_{jik} , {r}_{k i j} \}$$

since the real two-person passenger combination set RP_{3_2} and the user set RP_{3_1} can form

$$\frac{{\vert {RP}_{3} \vert}^{2}}{9}$$

possible two-person passenger combinations, the system cloud end server needs to perform no less than

$$\frac{{\vert {RP}_{3} \vert}^{2}}{9}$$

times of comparisons.

After calculation, the shortest passenger travel time of the three-person passenger combination at this time is as shown in Table 5:

TABLE 5
Shortest passenger travel time for three-person
passenger combination (“three-person pooling”)

| Passenger | {1, 3} | {2, 5} | {4, 9} | {8, 13} |
|---|---|---|---|---|
| 6 | 75.61954 | 96.55938 | 105.0158 | 162.8163 |
| 7 | 122.7871 | 93.90218 | 144.6582 | 71.89998 |
| 11 | 160.6306 | 87.97411 | 172.3003 | 129.1913 |
| 12 | 73.84387 | 123.8725 | 133.9681 | 137.4431 |

7) A second passenger combination matching problem of “three-person pooling” is solved, and aoptimal “three-person pooling” passenger matching scheme with an optimal passenger travel time is obtained.

For any two-person passenger combination {i, j}∈RP_{3_2}, a three-person passenger combination can only be formed by him with another user k∈RP_{3_1} ultimately. With a goal of minimizing the total passenger travel time, while under the user's “three-person pooling” demand, the matching problem of the three-person passenger combination can be transformed into a 0-1 programming model as follows:

$$min {\sum }_{\{ i , j \}} {\sum }_{k} {r}_{\overline{ijk}} {x}_{i j k}$$

$$s . t . \{ \begin{matrix}{\sum }_{\{ i , j \}} {x}_{ijk} = 1 , ∀ k ∈ {RP}_{{3}_{1}} \\ {\sum }_{k} {x}_{ijk} = 1 , ∀ \{ i , j \} ∈ {RP}_{{3}_{2}} \\ {x}_{ijk} = 0 or 1 , ∀ \{ i , j \} ∈ {RP}_{{3}_{2}} , k ∈ {RP}_{{3}_{1}}\end{matrix}$$

where xᵢⱼₖ is a variable from 0 to 1; in a solution result of the model, if the two-person passenger combination {i, j} and the user k constitute the three-person passenger combination {i, j, k}, then xᵢⱼₖ=1, otherwise xᵢⱼₖ=0.

Hungarian algorithm is used to solve the 0-1 programming model, and an obtained solution vector is x=(xᵢⱼₖ, {i, j}∈RP_{3_2}, k∈RP_{3_1})^{T}. The three-person passenger combination corresponding to xᵢⱼₖ=1 is screened out, the passenger combination set RP_{3_3} is constituted, which is referred to as the main passenger combination set 3, a quantity of set elements of which is |RP_{3_3}|=|RP₃|/3=4.

The set RC₃=RP_{3_3}∪{RP_{C3}} is allowed to represent the passenger combination set formed by the users of the “three-person pooling” demand, i.e. a union set of RP_{3_3} and RP_{C3}. Travel path and travel time for each passenger combination in the set RC₃ are recorded. A quantity |RC₃| of set elements represents the quantity of passenger combinations under the “three-person pooling” demand.

The travel paths and travel times for the passenger combinations in Table 6.

TABLE 6
Matching results of the “three-person pooling”

| Passenger | | Travel | |
|---|---|---|---|
| combination | Travel path | time | Set |
| {1, 3, 11} | 492 → 168 → 235→ 166 → 61 → 388 | 105.016 | RP₃_3 |
| {2, 5, 12} | 233 → 51 → 96 → 210 → 374 → 56 | 71.900 | |
| {4, 9, 7} | 383 → 368 → 104 → 486 → 112 → 20 | 87.974 | |
| {8, 13, 6} | 64 → 180 → 441 → 245 → 88 → 95 | 73.844 | |
| {10} | 100 → 459 | 69.585 | RP_{B3} |

The set RC is allowed to represent the passenger combination set formed by all users in the system, which is a union set of the passenger combination sets formed by users who have “two-person pooling” demand and “three-person pooling” demand, i.e. RC=RC₂∪RC₃. A quantity |RC| of set elements represents the quantity of passenger combinations in the system.

III. The passenger combinations and drivers in the system are matched. The system constructs a generalized driver set and a generalized passenger combination set, a 0-1 programming model of a driver-passenger combination matching process is solved, and screening is performed to obtain the driver-passenger combination matching scheme.

1) The passenger combination and the driver in the system are matched to form the driver-passenger combination, and a driver-passenger travel time and travel path of each driver-passenger combination are calculated.

The set of free drivers in the current system is V, wherein a quantity |V| of set elements represents a quantity of drivers in the system. The specific set information is shown in Table 7:

TABLE 7
Driver set information

| Driver | | Driver | | Driver | |
|---|---|---|---|---|---|
| serial | Driver | serial | Driver | serial | Driver |
| number | position | number | position | number | position |
| 1 | 228 | 11 | 232 | 21 | 66 |
| 2 | 279 | 12 | 386 | 22 | 219 |
| 3 | 361 | 13 | 340 | 23 | 142 |
| 4 | 158 | 14 | 375 | 24 | 181 |
| 5 | 318 | 15 | 443 | 25 | 139 |
| 6 | 92 | 16 | 311 | 26 | 245 |
| 7 | 221 | 17 | 338 | 27 | 399 |
| 8 | 497 | 18 | 50 | 28 | 265 |
| 9 | 488 | 19 | 154 | 29 | 447 |
| 10 | 277 | 20 | 241 | 30 | 254 |

For any driver v∈V, V_Oᵥ is allowed to represent a current position of v; for any passenger combination e∈RC, C_Oₑ and C_Dₑ are allowed to represent a start point and an end point of a passenger combination travel path of e, and C_Tₑ represents a passenger combination travel time of e.

The driver v EV and the passenger combination e∈RC are matched to constitute the driver-passenger combination {v, e}, and a travel trajectory thereof is that the driver v starts from the current position V_Oᵥ to C_Oₑ for picking up the first passenger until C_Dₑ where all the passengers get off the vehicle.

pᵥₑ is allowed to represent a travel path of the driver-passenger combination {v, e}, and tᵥₑ is allowed to represent a path travel time of the driver-passenger combination {v, e}, i.e. a driver-passenger travel time. A calculation formula is:

$$\begin{matrix}{p}_{v e} = \{ {V\_O}_{v} \to {C\_O}_{e} \to {C\_D}_{e} \} \\ {t}_{v e} = t ( {V\_O}_{v} , {C\_O}_{e} ) + {C\_T}_{e}\end{matrix}$$

where pᵥₑ represents a travel path from a current position V_Oᵥ to C_Dₑ by the driver; and t(V_Oᵥ, C_Oₑ) represents a travel time required by the driver v from the current position V_Oᵥ to the start point C_Oₑ of the travel path of the passenger combination e.

If in the system the quantity of drivers is |V|=30 and the quantity of passenger combinations is |RC|=16, then there are |V|·|RC|=480 possible driver-passenger combinations, and the driver-passenger travel time needs to be calculated for |V|·|RC|=480 times.

2) A preset quantity of drivers or passenger combinations are supplemented, so that a quantity of passenger combinations participating in matching is equal to a quantity of drivers, a matching problem of the driver-passenger combination is solved, and a driver-passenger matching scheme with an optimal total driver-passenger travel time is obtained.

A real driver and a virtual driver are collectively referred to as a generalized driver, and the real passenger combination and the virtual passenger combination are collectively referred to as the generalized passenger combination. The generalized driver and the generalized passenger combination are matched and can form a generalized driver-passenger combination.

If the driver v in the driver-passenger combination {v, e} is the real driver and the passenger combination e is the real passenger combination, then {v, e} is a real driver-passenger combination; otherwise, {v, e} is a virtual driver-passenger combination The real driver-passenger combination and the virtual driver-passenger combination are collectively referred to as the generalized driver-passenger combination.

Before solving the matching problem of driver-passenger combination, it is necessary to ensure that the quantity of passenger combinations participating in matching is equal to the quantity of drivers. Therefore, Inf is allowed to represent a sufficiently large, positive constant, a certain quantity of virtual drivers or virtual passenger combinations are supplemented according to actual situations, and a generalized driver set and a generalized passenger combination set are constructed. The specific processing is as follows:

If the quantity of real passenger combinations is greater than the quantity of real drivers, i.e. |RC|>|V|, (IRC|−|V|) virtual drivers are supplemented to the driver set V, constituting a generalized driver set V_{g}. The generalized passenger combination set RC_{g} is equal to the passenger combination set RC, i.e. RC_{g}=RC. The driver-passenger travel time tᵥₑ=Inf for the virtual driver v and any generalized passenger combination e∈RC_{g}.

If the quantity of real passenger combinations is less than the quantity of real drivers, i.e. |RC|<|V|, (|V|−|RC|) virtual passenger combinations are supplemented in the passenger combination set RC to form a generalized passenger combination set RC_{g}. The generalized driver set V_{g} is equal to the driver set V, i.e. V_{g}=V. The driver-passenger travel time tᵥₑ=Inf for the virtual passenger combination e and any generalized driver v∈V_{g}.

In this case |RC|<|V|, |V|−|RC|=30−16=14 virtual passenger combinations are supplemented in the passenger combination set RC.

After completing the supplement of the virtual drivers or the virtual passenger combinations, the driver-passenger combination matching is performed for the generalized driver set and the generalized passenger combination set.

For any generalized driver v∈V_{g}, a generalized driver-passenger combination can be formed by him with only one generalized passenger combination e∈RC_{g}. To minimize the total driver-passenger travel time, the matching problem of the driver-passenger combination can be transformed into a 0-1 programming model as follows:

$$min {{\sum }_{v = 1}}^{\vert {V}_{g} \vert} {{\sum }_{e = 1}}^{\vert {RC}_{g} \vert} {t}_{ve} {y}_{v e}$$

$$s . t . \{ \begin{matrix}{{\sum }_{e = 1}}^{\vert {RC}_{g} \vert} {y}_{ve} = 1 , ∀ e ∈ {RC}_{g} \\ {{\sum }_{v = 1}}^{\vert {V}_{g} \vert} {y}_{ve} = 1 , ∀ v ∈ {V}_{g} \\ {y}_{ve} = 0 or 1 , ∀ e ∈ {RC}_{g} , v ∈ {V}_{g}\end{matrix}$$

where yᵥₑ is a variable from 0 to 1; in a model solution result, if the generalized driver v and the generalized passenger combination e constitute the generalized driver-passenger combination {v, e}, then yᵥₑ=1, otherwise yᵥₑ=0.

Hungarian algorithm is applied to solve the 0-1 programming problem. The obtained solution vector is y=(yᵥₑ, v∈V_{g}, e∈RC_{g})^{T}. The generalized driver-passenger combinations corresponding to yᵥₑ=1 are screened out to constitute a generalized driver-passenger combination set VRC_{g}. Then the real driver-passenger combinations in the set VRC_{g} are selected to form a driver-passenger combination set VRC, wherein a quantity |VRC| of the set elements is equal to a minimum value of the quantity |RC| of passenger combinations and the quantity |V| of drivers, with a quantity |VRC|=min {|RC|, |V|} of the set elements. Travel path and travel time for each driver-passenger combination are recorded.

The travel path and travel time for each driver-passenger combination in the set VRC are shown in Table 8.

TABLE 8
Driver-passenger matching results

| | | | |
|---|---|---|---|
| | Passenger | | Travel |
| Driver | combination | Travel path | time |

Two-person pooling

| | | | |
|---|---|---|---|
| 20 | {1, 11} | 241 → 341 → 406 → 387 → 260 | 37.812 |
| 14 | {2, 8} | 375 → 391 → 199 → 432 → 445 | 85.797 |
| 9 | {3, 6} | 488 → 424 → 118 → 146 → 290 | 49.798 |
| 25 | {4, 7} | 139 → 433 → 315 → 400 → 391 | 34.272 |
| 19 | {5, 10} | 154 → 154 → 175 → 490 → 483 | 13.016 |
| 7 | {9, 12} | 221 → 107 → 464 → 342 → 99 | 85.998 |
| 13 | {13} | 340 → 58 → 162 | 55.896 |

Three-person pooling

| | | | |
|---|---|---|---|
| 17 | {1, 3, 11} | 338 → 492 → 168 → 235 → | 105.016 |
| | | 166 → 61 → 388 | |
| 4 | {2, 5, 12} | 158 → 233 → 51 → 96 → | 71.900 |
| | | 210 → 374 → 56 | |
| 10 | {4, 9, 7} | 277 → 383 → 368 → 104 → | 87.974 |
| | | 486 → 112 → 20 | |
| 18 | {8, 13, 6} | 50→ 64 →180 → 441 → | 73.844 |
| | | 245 → 88 → 95 | |
| 26 | {10} | 245 → 100 → 459 | 69.585 |

IV. The cloud end sends the driver-passenger matching scheme to the phone App of the driver and the passenger, executes the matching scheme, and completes the on-line ride-sharing service shared travel.

The system sends the matching result and travel path to the mobile phone App of the driver and passenger respectively in the form of an order. After receiving the order, the driver travels according to the travel path given by the order, and sequentially receives and sends each passenger. The user waits on the spot to get on the vehicle and pays a certain fee to the driver according to the price calculated by App after arriving at the destination to get off the vehicle. When the last passenger gets out of the vehicle and the payment is completed, the present Internet contract shared travel is completed. The above-mentioned embodiments are only preferred embodiments of the present disclosure. It should be pointed out that for one having ordinary skill in the art, several improvements and equivalent replacements can be made without departing from the principles of the present disclosure. These technical solutions that improve and equivalently replace the claims of the present disclosure fall within the scope of protection of the present disclosure.

1. A computer-implemented passenger matching method for on line ride-sharing service, wherein the method comprises the following steps that:
1) receiving, via an App and a communication network, pooling demands of on-line contract shared travel information by users;
assigning users into a plurality of user sets at a system cloud end server, and
pre-processing information about each user set to form a data file which is sent to the App of the users in the set;
2) after receiving a data file, calculating a shortest passenger travel time and travel path in App, and sending a result to the system cloud end server;
receiving the result to solve a 0-1 programming model of a passenger combination matching process by the system cloud end server, and screening to obtain a passenger combination matching scheme;
3) matching a passenger combination with a driver, and
constructing a generalized driver set and a generalized passenger combination set, determining a 0-1 programming model of a driver-passenger combination matching process, and screening to obtain a driver-passenger combination matching scheme; and
4) sending the driver-passenger matching scheme to the App of the driver and the users, executing the matching scheme, and completing the on-line ride-sharing service shared travel.

2. The computer-implemented passenger matching method for on line ride-sharing service according to claim 1, wherein in step 1), the travel information comprises a start point, an end server point and the pooling demand, and each user set is pre-processed, and the system cloud end server forms information about the start point and the end server point in the user set into the data file which is sent to a smart phone App of the users in the set.

3. The computer-implemented passenger matching method for on line ride-sharing service according to claim 1, wherein in step 2), the pooling demand is two-person pooling demand and three-person pooling demand.

4. The computer-implemented passenger matching method for on line ride-sharing service according to claim 3, wherein the specific method in step 1) is as follows that: the user i issues, via App, on-line contract shared travel information, comprising a travel start point Oᵢ, a travel end server point Dᵢ and the pooling demand Nᵢ, wherein a vehicle in a system is a five-seat automobile, and the automobile meets the pooling demand of the two-person pooling and the three-person pooling;
according to the users' pooling demand, the system cloud end server divides the users into two sets: RP_{A2} and RP_{A3}, the pooling demand of the users in the set RP_{A2} being the two-person pooling, namely Nᵢ=2, a quantity of users being |RP_{A2}|, while the pooling demand of the users in the set RP_{A3} being the three-person pooling, namely Nᵢ=3, a quantity of users being |RP_{A3}|;
taking the quantities |RP_{A2}| and |RP_{A3}| of the users in the set as a dividend, taking the pooling demands Nᵢ=2 and Nᵢ=3 of the users in the set as a divisor, a remainder operation is performed to obtain remainders |RP_{B2}| and |RP_{B3}|, namely:
$$\vert {RP}_{B 2} \vert = \vert {RP}_{A 2} \vert \%2$$
$$\vert {RP}_{B 3} \vert = \vert {RP}_{A 3} \vert \%3$$
where % represents a remainder symbol;
the system pre-processes the sets RP_{A2} and RP_{A3} as follows by:
for the two-person pooling set RP_{A2}: randomly selecting |RP_{B2}| of the users in the set RP_{A2}, wherein selected users constitute a set RP_{B2} referred to as a secondary user set 2; and unselected users constitute a set RP₂ referred to as a main user set 2; and RP₄₂=RP_{B2}∪RP₂, where if the remainder is |RP_{B2}|=0, then RP_{B2}=Ø, and there is a set relationship of RP_{A2}=RP₂;
for the three-person pooling set RP_{A3}: randomly selecting |RP_{B3}| of the users in the set RP_{A3}, wherein selected users constitute a set RP_{B3} referred to as a secondary user set 3; and unselected users constitute a set RP₃ referred to as a main user set 3; and RP_{A3}=RP_{B3}∪RP₃, where if the remainder is |RP_{R3}|=0, then RP_{B3}=Ø, and there is a set relationship of RP_{A3}=RP₃; and
after receiving the on-line contract shared travel information about the user and completing user set classification and pre-processing, the cloud end server respectively aggregates the travel start points and the travel end server points of the users in the sets RP₂ and RP₃, and extracts travel times between all nodes to form two data files: File2 and File3, and the cloud end server sends the data file File2 to all the users in the set RP₂, and sends the data file File3 to all the users in the set RP₃.

5. The computer-implemented passenger matching method for on line ride-sharing service according to claim 4, wherein in the step 2), a process of matching a passenger combination within the user set RP_{A2} with a two-person pooling demand is such that:
1) the user in RP₂ calculates a shortest passenger travel time and travel path of all possible two-person passenger combinations with himself as a first passenger, and returns a calculation result to the system cloud end server;
after the user of the user i∈RP₂ receives the data file File2 sent by the system cloud end server, the smart phone of the user takes the user i as the first passenger to calculate the shortest travel path and travel time of the two-person passenger combination formed by the user i and any other user j∈RP₂\{i}, and returns a calculation result to the system cloud end server, and the calculation formula is as follows:
$${P}_{ij} = \{ {O}_{i} \to {O}_{j} \to {D}_{i} \to {D}_{j} , {O}_{i} \to {O}_{j} \to {D}_{j} \to {D}_{i} \}$$
$${r}_{ij} = min \{ t ( {O}_{i} , {O}_{j} ) + t ( {O}_{j} , {D}_{i} ) + t ( {D}_{i} , {D}_{j} ) , t ( {O}_{i} , {O}_{j} ) + t ( {O}_{j} , {D}_{j} ) + t ( {D}_{j} , {D}_{i} ) \}$$
as stated above, taking the user i as the first passenger means taking the start point Oᵢ of the user i as a jumping-off place, so that the user d is the passenger gets aboard at first, and the driver needs to firstly receive the user i and j as the two passengers, and then send them to destinations respectively;
in the formula, in both Oᵢ→Oⱼ→Dᵢ→Dⱼ and Oᵢ→Oⱼ→Dⱼ→Dᵢ, paths are represented by nodes which are passed through successively, and all possible travel paths of the two-person passenger combination {i, j} are taken when the user i is the first passenger, and Pᵢⱼ represents a travel path set of the two-person passenger combination {i, j} when the user ¿ is the first passenger, and t(Oᵢ, Oⱼ), t(Oⱼ, Dᵢ), t(Dᵢ, Dᵢ), t(Oⱼ, Dⱼ), and t(Dᵢ, Dⱼ) all represent travel time between two nodes in parentheses; t(Oᵢ, Oⱼ)+t(Oⱼ, Dᵢ)+t(Dᵢ, Dⱼ) and t(Oᵢ, Oⱼ)+t(Oⱼ, Dᵢ)+t(Dⱼ, Dᵢ) both represent possible travel time of the two-person passenger combination {i, j} when the user i is the first passenger, and rᵢⱼ represents a shortest passenger travel time of the two-person passenger combination {i, j} when the user i is the first passenger;
2) the system cloud end server compares the shortest passenger travel times when different users in respective two-person passenger combinations serve as the first passenger, and determines the shortest passenger travel time and travel path of each two-person passenger combination;
within the two-person passenger combination {i, j}, a sum of the shortest passenger travel times rᵢⱼ and rⱼᵢ with the user i and the user i as the first passenger are compared with each other, the shortest passenger travel time r_{i̅j̅} of the two-person passenger combination is determined, and a travel path corresponding to r_{i̅j̅} is recorded, wherein the formula is as follows:
$${r}_{\overline{ij}} = min \{ {r}_{ij} , {r}_{ji} \}$$
3) the users within RP_{B2} are formed into a passenger combination RP_{C2}, and the shortest passenger travel time r_{C̅2̅} and travel path of the passenger combination are calculated;
under the two-person pooling demand of the user, if |RP_{B2}|≠0, then |RP_{B2}|=1, namely there is only one user in the “secondary user set 2” RP_{B2}, and the user is set as m∈RP_{B2}; the one user in the RP_{B2} is formed into a passenger combination represented by RP_{C2}, referred to as “secondary passenger combination 2”, there is RP_{C2}={m}, the shortest passenger travel time r_{C̅2̅}=t(Oₘ, Dₘ) of the “secondary passenger combination 2” RP_{C2}, and the corresponding travel path is Oₘ→Dₘ, and {RP_{C2}} represents a passenger combination set having only one element RP_{C2};
4) a matching problem of the two-person passenger combination is solved, and a two-person pooling passenger matching scheme with an optimal total passenger travel time is obtained;
for any user i∈RP₂, he can only form a two-person passenger combination with another user j∈RP₂\{i} ultimately, with a goal of minimizing the total passenger travel time, while under the user's two-person pooling demand, the matching problem of the two-person passenger combination is transformed into a 0-1 programming model as follows:
$$min {\sum }_{i = 1}^{\vert {RP}_{2} \vert} {\sum }_{j = 1}^{\vert {RP}_{2} \vert} {r}_{\overline{ij}} {x}_{ij}$$
$$s . t . \{ \begin{matrix}{\sum }_{i = 1}^{\vert {RP}_{2} \vert} {x}_{ij} = 1 , ∀ j ∈ {RP}_{2} \\ {\sum }_{j = 1}^{\vert {RP}_{2} \vert} {x}_{ij} = 1 , ∀ i ∈ {RP}_{2} \\ {x}_{ij} = 0 or 1 , ∀ i , j ∈ {RP}_{2}\end{matrix}$$
where xᵢⱼ is a 0-1 variable: in a solution result of the model, if the user i and the user j constitute a two-person passenger combination {i, j}, then xᵢⱼ=1, otherwise xᵢⱼ=0;
furthermore, there is no constraint in the 0-1 programming model i≠j, and the shortest passenger travel time r_{i̅j̅} for repeating the two-person passenger combination {i, i} is set as follows:
$${r}_{\overline{ii}} -= Inf , ∀ i ∈ {RP}_{2}$$
where Inf represents a positive infinite constant;
Hungarian algorithm is used to solve the 0-1 programming model, and an obtained solution vector is x=(xᵢⱼ, i∈RP₂, j∈RP₂)^{T}, the two-person passenger combination corresponding to xᵢⱼ=1 is screened out, the passenger combination set RP_{2_2} is formed, which is referred to as the main passenger combination set 2, a quantity of set elements of which is |RP_{2_2}=|RP₂|/2; and
a set RC₂=RP_{2_2}∪{RP_{C2}} is allowed to represent the passenger combination set formed by the users with the two-person pooling demand, i.e. a union set of RP_{2_2} and {RP_{C2}}, the travel path and travel time of each passenger combination in the set RC₂ are recorded, and a quantity |RC₂| of set elements represents a quantity of the passenger combinations under the two-person pooling demand.

6. The computer-implemented passenger matching method for on line ride-sharing service according to claim 4, wherein in the step 2), a process of matching a passenger combination within the user set RP_{A3} with a three-person pooling demand is such that:
1) the system cloud end server pre-supplements a certain quantity of virtual users on the basis of RP₃ to form a generalized user set RP_{E3}, wherein the user in RP₃ calculates the shortest passenger travel time and travel path of all possible two-person passenger combinations with himself as the first passenger, and returns a calculation result to the system cloud end server;
a quantity |RP₃|/3 of virtual users are pre-supplemented before passenger combination matching under the three-person pooling demand of the user, and the travel start points Oᵢ and the travel end server points Dᵢ of the virtual users are all virtual nodes; the virtual node does not exist in a real urban road network, and the distance to any real node is positively infinite, |RP₃|/3 virtual users constitute a virtual user set RP_{V3}, and a union set of the virtual user set RP_{V3} and RP₃ is the generalized user set RP_{E3}, namely RP_{E3}=RP₃∈RP_{V3}, Inf representing a positive infinite constant;
after the smart phone of the user i∈RP₃ receives the data file File3 sent by the cloud end server, the smart phone of the user i takes the user i as the first passenger to calculate the shortest travel path and travel time of the two-person passenger combination formed by the user i and any other user j∈RP₃ \{i}, and returns a calculation result to the system cloud end server, and the calculation formula is as follows:
$${P}_{ij} = \{ {O}_{i} \to {O}_{j} \to {D}_{i} \to {D}_{j} , {O}_{i} \to {O}_{j} \to {D}_{j} \to {D}_{i} \}$$
$${r}_{ij} = min \{ t ( {O}_{i} , {O}_{j} ) + t ( {O}_{j} , {D}_{i} ) + t ( {D}_{i} , {D}_{j} ) , t ( {O}_{i} , {O}_{j} ) + t ( {O}_{j} , {D}_{j} ) + t ( {D}_{j} , {D}_{i} ) \}$$
as stated above, taking the user i as the first passenger, i.e. taking the start point Oᵢ of the user i as a jumping-off place, so that the user i is the passenger gets aboard at first, the driver firstly receives the users i and j as the two passengers, and then send them to destinations respectively;
in the formula, in both Oᵢ→Oⱼ→Dᵢ→Dⱼ and Oᵢ→Oⱼ→Dⱼ→Dᵢ, paths are represented by nodes which are passed through successively, and all possible travel paths of the two-person passenger combination {i, j} are taken when the user i is the first passenger, and Pᵢⱼ represents a travel path set of the two-person passenger combination {i, j} when the user i is the first passenger, and t(Oᵢ, Oⱼ), t(Oⱼ, Dᵢ), t(Dᵢ, Dⱼ), t(Oⱼ, Dⱼ), and t(Dᵢ, Dⱼ) all represent travel time between two nodes in parentheses, t(Oᵢ, Oⱼ)+t(Oⱼ, Dᵢ)+t(Dᵢ, Dⱼ) and t(Oᵢ, Oⱼ)+t(Oⱼ, Dᵢ)+t(Dⱼ, Dᵢ) both represent possible travel time of the two-person passenger combination {i, j} when the user i is the first passenger, and rᵢⱼ represents a shortest passenger travel time of the two-person passenger combination {i, j} when the user i is the first passenger;
2) the system cloud end server compares the shortest passenger travel times when different users in respective two-person passenger combinations serve as the first passenger, and determines the shortest passenger travel time and travel path of each two-person passenger combination;
within the two-person passenger combination {i, j}, a sum of the shortest passenger travel times rᵢⱼ and rⱼᵢ with the user i and the user j as the first passenger are compared with each other, the shortest passenger travel time r_{i̅j̅} of the two-person passenger combination is determined, and a travel path corresponding to r_{i̅j̅} is recorded, wherein the formula is as follows:
$${r}_{\overline{ij}} = min \{ {r}_{ij} , {r}_{ji} \}$$
3) all the users within “secondary user set 3” RP_{B3} are formed into a passenger combination RP_{C3}, and the shortest passenger travel time r_{C̅3̅} and travel path of the passenger combination are calculated;
if |RP_{B3}|≠0 under the user's “three-person pooling” demand, then |RP_{B3}|=1 or |RP_{B3}|=2, namely, there are 1 or 2 users in the “secondary user set” RP_{B3}, all the users in the set RP_{B3} are formed into a passenger combination represented by RP_{C3}, referred to as “secondary passenger combination 3”, and r_{C̅3̅} is allowed to represent the shortest passenger travel time of the passenger combination RP_{C3}, and {RP_{C3}} is allowed to represent a passenger combination set comprising only one element of the passenger combination RP_{C3}, referred to as “secondary passenger combination set 3”;
if there is one user in the set RP_{B3}, the user is set to be m∈RP_{B3}, then the “secondary passenger combination 3” RP_{C3}={m}, the shortest passenger travel time r_{C̅3̅}=t(Oₘ, Dₘ) of RP_{C3} and a corresponding travel path is Oₘ→Dₘ;
if there are two users in the set RP_{B3}, represented as m₁, m₂∈RP_{B3}, then “secondary passenger combination 3” RP_{C3}={m₁, m₂} is a two-person passenger combination, and the shortest passenger travel time r_{C̅3̅} of RP_{C3} is the shortest passenger travel time [symbol] of the two-person passenger combination {m₁, m₂} and for [symbol] it is also necessary to first respectively calculate the shortest passenger travel times rₘ_{₁}ₘ_{₂} and rₘ_{₁}ₘ_{₂} with m₁ and m₂ as the first passenger, and then make comparison to obtain the shortest passenger travel time [symbol] of the two-person passenger combination {m₁, m₂}, and a travel path corresponding to [symbol] is recorded;
4) to solve a first passenger combination matching problem under the “three-person pooling” demand of the user, |RP_{B3}|/2 generalized two-person passenger combinations is matched in the generalized user set RP_{E3}, and then real users in |RP₃|/2 real two-person passenger combinations and |RP₃|/2 mixed two-person passenger combinations are selected from the generalized two-person passenger combinations; real users and virtual users are collectively referred to as generalized users;
if the passengers i and j in the two-person passenger combination {i, j} are both real users, then {i, j} is taken as the real two-person passenger combination; if the passenger i in the two-person passenger combination {i, j} is a real user and the passenger i is a virtual user, or if the passenger i is a virtual user and the passenger j is a real user, then {i, j} is taken as the mixed two-person passenger combination; if the passengers i and j in the two-person passenger combination {i, j} are both virtual users, then {i, j} is taken as a virtual two-person passenger combination, while the real two-person passenger combination, the mixed two-person passenger combination and the virtual two-person passenger combination are collectively referred to as the generalized two-person passenger combination;
in the first passenger combination matching process under the three-person pooling demand of the user, |RP_{E3}|/2 generalized two-person passenger combinations are matched in the generalized user set RP_{E3}, and for any generalized user i∈RP_{E3}, the generalized two-person passenger combination can only be formed by him with another generalized user j∈RP_{E3} \{i}, and aiming at minimizing the total passenger travel time, the matching problem of the generalized two-person passenger combination can be transformed into a 0-1 programming model as follows:
$$min {{\sum }_{i = 1}}^{\vert {RP}_{E 3} \vert} {\sum }_{j = 1}^{\vert {RP}_{E 3} \vert} {r}_{\overline{ij}} {x}_{ij}$$
$$s . t . \{ \begin{matrix}{\sum }_{i = 1}^{\vert {RP}_{E 3} \vert} {x}_{ij} = 1 , ∀ j ∈ {RP}_{E 3} \\ {\sum }_{j = 1}^{\vert {RP}_{E 3} \vert} {x}_{ij} = 1 , ∀ i ∈ {RP}_{E 3} \\ {x}_{ij} = 0 or 1 , ∀ i , j ∈ {RP}_{E 3}\end{matrix}$$
where xᵢⱼ is a variable from 0 to 1; in a model solution result, if the generalized user i and the generalized user j constitute the generalized two-person passenger combination {i, j}, then xᵢⱼ=1, otherwise xᵢⱼ=0;
since there is no constraint i≠j in the 0-1 programming model, the 0-1 programming model not only has the repeated two-person passenger combination {i, i} and the related parameter r_{i̅i̅} and variable xᵢᵢ, but also has the virtual user and the mixed two-person passenger combination and the virtual two-person passenger combination which may be formed;
in order to match the real two-person passenger combination as much as possible, and at the same time enable the 0-1 programming model to solve the first passenger matching process of “three-person pooling”, Inf is allowed to represent a positive infinite constant, and the shortest passenger travel time of any generalized two-person passenger combination {i, j} is set as follows:
if i∈RP₃, j∈RP₃ and i≠j, it is the real two-person passenger combination, and the shortest passenger travel time thereof is r_{i̅j̅};
if i∈RP₃, j∈RP_{V3} or j∈RP₃, i∈RP_{V3}, it is the mixed two-person passenger combination, and the shortest passenger travel time thereof is Inf;
if i∈RP_{V3}, j∈RP_{V3} and i≠j, it is the virtual two-person passenger combination, and the shortest passenger travel time thereof is 2*Inf;
for the repeated two-person passenger combination {i, i}, the shortest passenger time r_{i̅i̅} thereof is set as 2*Inf;
the Hungarian algorithm is applied to solve the 0-1 programming model, and the solved vector is x=(xᵢⱼ, i∈RP_{E3}, j∈RP_{E3})^{T}, 2*(|RP₃|/3) generalized two-person passenger combinations corresponding to xᵢⱼ=1 are screened out, wherein there are |RP₃|/3 real two-person passenger combinations and |RP₃|/3 mixed two-person passenger combinations;

|RP₃|/3 real two-person passenger combinations are screened out to construct the real two-person passenger combination set RP_{3_2} and the quantity of set elements is |RP_{3_2}=|RP₃|/3; then the real users in |RP₃|/3 mixed two-person passenger combinations are screened out to construct the user set RP_{3_1} and the quantity of set elements is |RP_{3_1}|=|RP₃|/3;
after the system cloud end server completes the first passenger combination matching of the three-person pooling, the start points and the end server points of two users of each real two-person passenger combination in the real two-person passenger combination set RP_{3_2} are extracted to form a data file File3_2; start points and end server points of each user in the user set RP_{3_1} are extracted to form a data file File3_1; after forming the data files, the system cloud sends the data files File3_1 and File3_2 to all the smart phones of the users in RP₃ again;
5) the user in RP₃ calculates a shortest passenger travel time and travel path of all possible three-person passenger combinations with himself as a first passenger, and returns a calculation result to the system cloud end server;
the real two-person passenger combination set RP_{3_2} and the user set RP_{3_1} are obtained in the first passenger combination matching process of the three-person pooling, so that the real two-person passenger combination {i, j}∈RP_{3_2} and the real user k∈RP_{3_1}, then the user i, the user j and the user k constitute a three-person passenger combination {i, j, k};
a step of calculating the shortest passenger travel time of the three-person passenger combination {i, j, k} is as follows; smart phones of the user i, j∈{i, j}, {i, j}∈RP_{3_2} and the user k∈RP_{3_1} receive the data files File3_1 and File3_2 sent by the cloud end server; after receiving the files File3_1 and File3_2, the smart phone of the user i takes the user i as the first passenger to calculate the shortest travel path and travel time of the three-person passenger combination formed by the user i, the user j and the user k, and returns a calculation result to the system cloud end server, and the calculation formula is as follows:
$${P}_{ijk} = \{ \begin{matrix}{O}_{i} \to {O}_{j} \to {O}_{k} \to {D}_{i} \to {D}_{j} \to {D}_{k} , \\ {O}_{i} \to {O}_{k} \to {O}_{j} \to {D}_{i} \to {D}_{j} \to {D}_{k} , \\ {O}_{i} \to {O}_{j} \to {O}_{k} \to {D}_{i} \to {D}_{k} \to {D}_{j} , \\ {O}_{i} \to {O}_{k} \to {O}_{j} \to {D}_{i} \to {D}_{k} \to {D}_{j} , \\ {O}_{i} \to {O}_{j} \to {O}_{k} \to {D}_{j} \to {D}_{i} \to {D}_{k} , \\ {O}_{i} \to {O}_{k} \to {O}_{j} \to {D}_{j} \to {D}_{i} \to {D}_{k} , \\ {O}_{i} \to {O}_{j} \to {O}_{k} \to {D}_{j} \to {D}_{k} \to {D}_{i} , \\ {O}_{i} \to {O}_{k} \to {O}_{j} \to {D}_{j} \to {D}_{k} \to {D}_{i} , \\ {O}_{i} \to {O}_{j} \to {O}_{k} \to {D}_{k} \to {D}_{i} \to {D}_{j} , \\ {O}_{i} \to {O}_{k} \to {O}_{j} \to {D}_{k} \to {D}_{i} \to {D}_{j} , \\ {O}_{i} \to {O}_{j} \to {O}_{k} \to {D}_{k} \to {D}_{j} \to {D}_{i} , \\ {O}_{i} \to {O}_{k} \to {O}_{j} \to {D}_{k} \to {D}_{j} \to {D}_{i}\end{matrix} \}$$
$${r}_{ijk} = min \{ \begin{matrix}t ( {O}_{i} , {O}_{j} ) + t ( {O}_{j} , {O}_{k} ) + t ( {O}_{k} , {D}_{i} ) + t ( {D}_{i} , {D}_{j} ) + t ( {D}_{j} , {D}_{k} ) , \\ t ( {O}_{i} , {O}_{k} ) + t ( {O}_{k} , {O}_{j} ) + t ( {O}_{j} , {D}_{i} ) + t ( {D}_{i} , {D}_{j} ) + t ( {D}_{j} , {D}_{k} ) , \\ t ( {O}_{i} , {O}_{j} ) + t ( {O}_{j} , {O}_{k} ) + t ( {O}_{k} , {D}_{i} ) + t ( {D}_{i} , {D}_{k} ) + t ( {D}_{k} , {D}_{j} ) , \\ t ( {O}_{i} , {O}_{k} ) + t ( {O}_{k} , {O}_{j} ) + t ( {O}_{j} , {D}_{i} ) + t ( {D}_{i} , {D}_{k} ) + t ( {D}_{k} , {D}_{j} ) , \\ t ( {O}_{i} , {O}_{j} ) + t ( {O}_{j} , {O}_{k} ) + t ( {O}_{k} , {D}_{j} ) + t ( {D}_{j} , {D}_{i} ) + t ( {D}_{i} , {D}_{k} ) , \\ t ( {O}_{i} , {O}_{k} ) + t ( {O}_{k} , {O}_{j} ) + t ( {O}_{j} , {D}_{j} ) + t ( {D}_{j} , {D}_{i} ) + t ( {D}_{i} , {D}_{k} ) , \\ t ( {O}_{i} , {O}_{j} ) + t ( {O}_{j} , {O}_{k} ) + t ( {O}_{k} , {D}_{j} ) + t ( {D}_{j} , {D}_{k} ) + t ( {D}_{k} , {D}_{i} ) , \\ t ( {O}_{i} , {O}_{k} ) + t ( {O}_{k} , {O}_{j} ) + t ( {O}_{j} , {D}_{j} ) + t ( {D}_{j} , {D}_{k} ) + t ( {D}_{k} , {D}_{i} ) , \\ t ( {O}_{i} , {O}_{j} ) + t ( {O}_{j} , {O}_{k} ) + t ( {O}_{k} , {D}_{k} ) + t ( {D}_{k} , {D}_{i} ) + t ( {D}_{i} , {D}_{j} ) , \\ t ( {O}_{i} , {O}_{k} ) + t ( {O}_{k} , {O}_{j} ) + t ( {O}_{j} , {D}_{k} ) + t ( {D}_{k} , {D}_{i} ) + t ( {D}_{i} , {D}_{j} ) , \\ t ( {O}_{i} , {O}_{j} ) + t ( {O}_{j} , {O}_{k} ) + t ( {O}_{k} , {D}_{k} ) + t ( {D}_{k} , {D}_{j} ) + t ( {D}_{j} , {D}_{i} ) , \\ t ( {O}_{i} , {O}_{k} ) + t ( {O}_{k} , {O}_{j} ) + t ( {O}_{j} , {D}_{k} ) + t ( {D}_{k} , {D}_{j} ) + t ( {D}_{j} , {D}_{i} )\end{matrix} \}$$
as stated above, in order to achieve the three-person pooling demand of the user, the driver first picks up the three passengers and then sends them to destinations respectively, where Pᵢⱼₖ represents a travel path set of the three-person passenger combination {i, j, k} when the user i is the first passenger, wherein the elements Oⱼ→Oᵢ→Oₖ→Dᵢ→Dⱼ→Dₖ are all paths, which are represented by nodes that are passed through successively, and rᵢⱼₖ represent the shortest passenger travel time of the three-person passenger combination {i, j, k} when the user i is the first passenger, while the elements t(Oₖ, Oⱼ)+t(Oⱼ, Oᵢ)+t(Oᵢ, Dᵢ)+t(Dᵢ, Dⱼ)+t(Dⱼ, Dₖ) all represent possible travel times of the three-person passenger combination {i, j, k};
6) the system cloud end server compares the shortest passenger travel times when different users in respective three-person passenger combinations serve as the first passenger, and determines the shortest passenger travel time and travel path of each three-person passenger combination;
within the three-person passenger combination {i, j, k}, the system compares the shortest passenger travel times rᵢⱼₖ, rⱼᵢₖ, and rₖᵢⱼ with the user i, the user j and the user k as the first passenger, determines the shortest passenger travel time r_{i̅j̅k̅} of the three-person passenger combination, and records a travel path corresponding to r_{i̅j̅k̅} and the formula is as follows:
$${r}_{\overline{ijk}} = min \{ {r}_{ijk} , {r}_{jik} , {r}_{kij} \}$$
7) a second passenger combination matching problem of three-person pooling is solved, and a three-person pooling passenger matching scheme with an optimal passenger travel time is obtained;
for any two-person passenger combination {i, j}∈RP_{3_2}, it can only form a three-person passenger combination with another user k∈RP_{3_1} ultimately, with a goal of minimizing the total passenger travel time, while under the user's three-person pooling demand, the matching problem of the two-person passenger combination can be transformed into a 0-1 programming model as follows:
$$min {\sum }_{\{ i , j \}} {\sum }_{k} {r}_{\overline{ijk}} {x}_{ijk}$$
$$s . t . \{ \begin{matrix}{\sum }_{\{ i , j \}} {x}_{ijk} = 1 , ∀ k ∈ {RP}_{3 \_ 1} \\ {\sum }_{k} {x}_{ijk} = 1 , ∀ \{ i , j \} ∈ {RP}_{3 \_ 2} \\ {x}_{ijk} = 0 or 1 , ∀ \{ i , j \} ∈ {RP}_{3 \_ 2} , k ∈ {RP}_{3 \_ 1}\end{matrix}$$
where xᵢⱼₖ is a variable from 0 to 1; in a solution result of the model, if the two-person passenger combination {i, j} and the user k constitute the three-person passenger combination {i, j, k}, then xᵢⱼₖ=1, otherwise xᵢⱼₖ=0;
Hungarian algorithm is used to solve the 0-1 programming model, and an obtained solution vector is x=(xᵢⱼₖ, {i, j}∈RP_{3_2}, k∈RP_{3_1})^{T}, the three-person passenger combination corresponding to xᵢⱼₖ=1 is screened out, the passenger combination set RP_{3_3} is constituted, which is referred to as the main passenger combination set 3, a quantity of set elements of which is |RP_{3_3}|=|RP₃|/3; and
a set RC₃=RP_{3_3}∪{RP_{C3}} is allowed to represent the passenger combination set formed by the users with the three-person pooling demand, i.e. a union set of RP_{3_3} and RP_{C3}, the travel path and travel time of each passenger combination in the set RC₃ are recorded, and a quantity |RC₃| of set elements represents a quantity of the passenger combinations under the three-person pooling demand; the set RC is allowed to represent a passenger combination set formed by all users in the system, which a union set of the passenger combination sets formed by users with two-passenger pooling demand and three-passenger pooling demand, that is RC=RC₂∪RC₃, a quantity |RC| of set elements represents a quantity of the passenger combinations in the system.

7. The computer-implemented passenger matching method for on line ride-sharing service according to claim 6, wherein in the step 3), a process of matching the passenger combination within each passenger set is such that:
5.1) the passenger combination and the driver in the system are matched to form the driver-passenger combination, and a driver-passenger travel time and travel path of each driver-passenger combination are calculated;
5.2) a preset quantity of drivers or passenger combinations are supplemented, so that a quantity of passenger combinations participating in matching is equal to a quantity of drivers, a matching problem of the driver-passenger combination is solved, and a driver-passenger matching scheme with an optimal total driver-passenger travel time is obtained.

8. The computer-implemented passenger matching method for on line ride-sharing service according to claim 7, wherein a method of the step 5.1) is as follows such that:
V is allowed to represent a driver set in the system, and a quantity |V| of set elements represents the quantity of drivers in the system;
for any driver v∈V, V_Oᵥ is allowed to represent a current position of v; for any passenger combination e∈RC, C_Oₑ and C_Dₑ are allowed to represent a start point and an end server point of a passenger combination travel path of e, and C_Tₑ represents a passenger combination travel time of e;
the driver v∈V and the passenger combination e∈RC are matched to constitute the driver-passenger combination {v, e}, and a travel trajectory thereof is that the driver v starts from the current position V_Oᵥ to C_Oₑ for picking up the first passenger until C_Dₑ where all the passengers get off the vehicle;
pᵥₑ is allowed to represent a travel path of the driver-passenger combination {v, e} and tᵥₑ is allowed to represent a path travel time of the driver-passenger combination {v, e}, i.e. a driver-passenger travel time, and the calculation formula is:
$${p}_{ve} = \{ {V\_O}_{v} \to {C\_O}_{e} \to {C\_D}_{e} \}$$
$${t}_{ve} = t ( {V\_O}_{v} , {C\_O}_{e} ) + {C\_T}_{e}$$
where pᵥₑ represents a travel path from a current position V_Oᵥ to C_Dₑ by the driver, and t(V_Oᵥ, C_Oₑ) represents a travel time required by the driver u from the current position V_Oᵥ to the start point C_Oₑ of the travel path of the passenger combination e.

9. The computer-implemented passenger matching method for on line ride-sharing service according to claim 8, wherein in the step 5.2), a method that a preset quantity of drivers or passenger combinations are supplemented so that a quantity of passenger combinations participating in matching is equal to a quantity of drivers is as follows such that:
a real driver and a virtual driver are collectively referred to as a generalized driver, and the real passenger combination and the virtual passenger combination are collectively referred to as the generalized passenger combination, and the generalized driver and the generalized passenger combination are matched and can form a generalized driver-passenger combination;
if the driver u in the driver-passenger combination {v, e} is the real driver and the passenger combination e is the real passenger combination, then {v, e} is a real driver-passenger combination; otherwise, {v, e} is a virtual driver-passenger combination, and the real driver-passenger combination and the virtual divisor-multiplier combination are collectively referred to as the generalized divisor-multiplier combination;
Inf is allowed to represent a positive infinite constant, a certain quantity of virtual drivers or virtual passenger combinations are supplemented according to actual situations, and a generalized driver set and a generalized passenger combination set are constructed, and the specific processing is as follows:
if a quantity of real passenger combinations is greater than a quantity of real drivers, namely |RC|>|V|, (|RC|−|V|) virtual drivers are supplemented in the driver set V to constitute the generalized driver set V_{g}, wherein the generalized passenger combination set RC_{g} is equal to the passenger combination set RC, namely RC_{g}=RC, with the driver-passenger travel time tᵥₑ=Inf of the virtual driver u and any generalized passenger combination e∈RC_{g};
if the quantity of real passenger combinations is less than the quantity of real drivers, namely |RC|<|V|, (|V|−|RC|) virtual passenger combinations are supplemented in the passenger combination set RC to constitute the generalized passenger combination set RC_{g}, the generalized driver set V_{g} is equal to the driver set V, namely V_{g}=V, with the driver-passenger travel time tᵥₑ=Inf of the virtual passenger combination e and any generalized driver v∈V_{g}.

10. The computer-implemented passenger matching method for on line ride-sharing service according to claim 9, wherein for the generalized driver set and the generalized passenger combination set, a method for driver-passenger combination matching is as follows such that:
for any generalized driver v∈V_{g} the generalized driver-passenger combination can only be formed by him with one generalized passenger combination e∈RC_{g}, and with a goal of minimizing the total driver-passenger travel time, the matching problem of the driver-passenger combination can be transformed into a 0-1 programming model as follows:
$$min {\sum }_{v = 1}^{\vert {V}_{g} \vert} {\sum }_{e = 1}^{\vert {RC}_{g} \vert} {t}_{ve} {y}_{ve}$$
$$s . t . \{ \begin{matrix}{\sum }_{e = 1}^{\vert {RC}_{g} \vert} {y}_{ve} = 1 , ∀ e ∈ {RC}_{g} \\ {\sum }_{v = 1}^{\vert {V}_{g} \vert} {y}_{ve} = 1 , ∀ v ∈ {V}_{g} \\ {y}_{ve} = 0 or 1 , ∀ e ∈ {RC}_{g} , v ∈ {V}_{g}\end{matrix}$$
where yᵥₑ is a variable from 0 to 1; in a model solution result, if the generalized driver v and the generalized passenger combination e constitute the generalized driver-passenger combination {v, e}, then yᵥₑ=1, otherwise yᵥₑ=0;
the Hungarian algorithm is applied to solve the 0-1 programming problem, and the obtained solution vector is y=(yᵥₑ, v∈V_{g}, e∈RC_{g})^{T}, the generalized driver-passenger combinations corresponding to yᵥₑ=1 therein are screened out to constitute a generalized driver-passenger combination set VRC_{g}, and then the real driver-passenger combinations in the set VRC_{g}, are screened out to constitute a driver-passenger combination set VRC, wherein a quantity |VRC| of set elements is equal to a minimum value of a quantity |RC| of passenger combinations and a quantity |V| of drivers, namely |VRC|=min{|RC|, |V|}, and the travel path and travel time of each driver-passenger combination is recorded.

11. A computer system for passenger matching, comprising:
one or more processors, one or more non-transitory computer-readable memories, one or more non-transitory computer-readable tangible storage medium, and program instructions stored on at least one of the one or more tangible storage medium for execution by at least one of the one or more processors via at least one of the one or more memories, wherein the computer system is capable of performing a method, comprising computer-implemented passenger matching method for on line ride-sharing service, wherein the method comprises the following steps that:
1) receiving, via an App and a communication network, a user publishes a pooling demands of on-line contract shared travel information by users via App;
assigning a system cloud end server divides users into a plurality of user sets at a system cloud end server, and pre-processes
pre-processing information about each user set to form a data file which is sent to the App of the users in the set;
2) after receiving a data file, the user calculates calculating a shortest passenger travel time and travel path in App, and returns sending a result to the system cloud end server;
the system cloud end server receives receiving the result to solve a 0-1 programming model of a passenger combination matching process by the system cloud end server, and screening is performed to obtain a passenger combination matching scheme;
3) matching a passenger combination is matched with a driver, and
constructing the system cloud end server constructs a generalized driver set and a generalized passenger combination set, determining a 0-1 programming model of a driver-passenger combination matching process is solved, and screening is performed to obtain a driver-passenger combination matching scheme; and
4) the system cloud end server sends sending the driver-passenger matching scheme to the App of the driver and the users, executes executing the matching scheme, and completes completing the on-line ride-sharing service shared travel.

12. The computer system for passenger matching according to claim 11, wherein in step 1), the travel information comprises a start point, an end server point and the pooling demand, and each user set is pre-processed, and the system cloud end server forms information about the start point and the end server point in the user set into the data file which is sent to a smart phone App of the users in the set.

13. The computer system for passenger matching according to claim 11, wherein in step 2), the pooling demand is two-person pooling demand and three-person pooling demand.

14. The computer system for passenger matching according to claim 13, wherein the specific method in step 1) is as follows that:
the user i issues, via App, on-line contract shared travel information, comprising a travel start point Oᵢ, a travel end server point Dᵢ and the pooling demand Nᵢ, wherein a vehicle in a system is a five-seat automobile, and the automobile meets the pooling demand of the two-person pooling and the three-person pooling;
according to the users' pooling demand, the system cloud end server divides the users into two sets: RP_{A2} and RP_{A3}, the pooling demand of the users in the set RP_{A2} being the two-person pooling, namely Nᵢ=2, a quantity of users being |RP_{A2}|, while the pooling demand of the users in the set RP_{A3} being the three-person pooling, namely Nᵢ=3, a quantity of users being |RP_{A3}|;
taking the quantities |RP_{A2}| and |RP_{A3}| of the users in the set as a dividend, taking the pooling demands Nᵢ=2 and Nᵢ=3 of the users in the set as a divisor, a remainder operation is performed to obtain remainders |RP_{B2}| and |RP_{B3}|, namely:
$$\vert R {P}_{B 2} \vert = \vert R {P}_{A 2} \vert \%2 \\ \vert R {P}_{B 3} \vert = \vert R {P}_{A 3} \vert \%3$$
where % represents a remainder symbol;
the system pre-processes the sets RP_{A2} and RP_{A3} as follows by:
for the two-person pooling set RP_{A2}: randomly selecting |RP_{B2}| of the users in the set RP_{A2},
wherein selected users constitute a set RP_{B2} referred to as a secondary user set 2; and unselected users constitute a set RP₂ referred to as a main user set 2; and RP_{A2}=RP_{B2}∪RP₂, where if the remainder is |RP_{B2}|=0, then RP_{B2}=Ø, and there is a set relationship of RP_{A2}=RP₂;
for the three-person pooling set RP_{A3}: randomly selecting |RP_{B3}| of the users in the set RP_{A3}, wherein selected users constitute a set RP_{B3} referred to as a secondary user set 3; and unselected users constitute a set RP₃ referred to as a main user set 3; and RP₄₃=RP_{B3}∪RP₃, where if the remainder is |RP_{B3}|=0, then RP_{B3}=Ø, and there is a set relationship of RP_{A3}=RP₃; and
after receiving the on-line contract shared travel information about the user and completing user set classification and pre-processing, the cloud end server respectively aggregates the travel start points and the travel end server points of the users in the sets RP₂ and RP₃, and extracts travel times between all nodes to form two data files: File2 and File3, and the cloud end server sends the data file File2 to all the users in the set RP₂, and sends the data file File3 to all the users in the set RP₃.

15. The computer system for passenger matching according to claim 14, wherein in the step 2), a process of matching a passenger combination within the user set RP_{A2} with a two-person pooling demand is such that:
1) the user in RP₂ calculates a shortest passenger travel time and travel path of all possible two-person passenger combinations with himself as a first passenger, and returns a calculation result to the system cloud end server;
after the user of the user i∈RP₂ receives the data file File2 sent by the system cloud end server, the smart phone of the user i takes the user i as the first passenger to calculate the shortest travel path and travel time of the two-person passenger combination formed by the user i and any other user j∈RP₂\{i} and returns a calculation result to the system cloud end server, and the calculation formula is as follows:
$${p}_{ij} = \{ {O}_{i} \to {O}_{j} \to {D}_{i} \to {D}_{j} , {O}_{i} \to {O}_{j} \to {D}_{j} \to {D}_{i} \} \\ {r}_{ij} = min \{ t ( {O}_{i} , {O}_{j} ) + t ( {O}_{j} , {D}_{i} ) + t ( {D}_{i} , {D}_{j} ) , t ( {O}_{i} , {O}_{j} ) + t ( {O}_{j} , {D}_{j} ) + t ( {D}_{j} , {D}_{i} ) \}$$
as stated above, taking the user i as the first passenger means taking the start point Oᵢ of the user i as a jumping-off place, so that the user i is the passenger gets aboard at first, and the driver needs to firstly receive the user i and j as the two passengers, and then send them to destinations respectively;
in the formula, in both Oᵢ→Oⱼ→Dᵢ→Dⱼ and Oᵢ→Oⱼ→Dⱼ→Dᵢ, paths are represented by nodes which are passed through successively, and all possible travel paths of the two-person passenger combination {i, j} are taken when the user i is the first passenger, and Pᵢⱼ represents a travel path set of the two-person passenger combination {i, j} when the user i is the first passenger, and t(Oᵢ, Oⱼ), t(Oⱼ, Dᵢ), t(Dᵢ, Dⱼ), t(Oⱼ, Dᵢ), and t(Dᵢ, Dⱼ) all represent travel time between two nodes in parentheses; t(Oᵢ, Oⱼ)+t(Oⱼ, Dᵢ)+t(Dᵢ, Dⱼ) and t(Oᵢ, Oⱼ)+t(Oⱼ, Dᵢ)+t(Dⱼ, Dᵢ) both represent possible travel time of the two-person passenger combination {i, j} when the user i is the first passenger, and rᵢⱼ represents a shortest passenger travel time of the two-person passenger combination {i, j} when the user i is the first passenger;
2) the system cloud end server compares the shortest passenger travel times when different users in respective two-person passenger combinations serve as the first passenger, and determines the shortest passenger travel time and travel path of each two-person passenger combination;
within the two-person passenger combination {i,j}, a sum of the shortest passenger travel times rᵢⱼ and rⱼᵢ with the user i and the user i as the first passenger are compared with each other, the shortest passenger travel time r_{i̅j̅} of the two-person passenger combination is determined, and a travel path corresponding r_{i̅j̅} to is recorded, wherein the formula is as follows:
$${r}_{\overline{ij}} = min \{ {r}_{ij} , {r}_{ji} \}$$
3) the users within RP_{B2} are formed into a passenger combination RP_{C2}, and the shortest passenger travel time r_{C̅2̅} and travel path of the passenger combination are calculated;
under the two-person pooling demand of the user, if |RP_{B2}|≠0, then |RP_{B2}|=1, namely there is only one user in the “secondary user set 2” RP_{B2}, and the user is set as m∈RP_{B2}; the one user in the RP_{B2} is formed into a passenger combination represented by RP_{C2}, referred to as “secondary passenger combination 2”, there is RP_{C2}={m}, the shortest passenger travel time r_{C̅2̅}=t(Oₘ, Dₘ) of the “secondary passenger combination 2” RP_{C2}, and the corresponding travel path is Oₘ→Dₘ, and {RP_{C2}} represents a passenger combination set having only one element RP_{C2};
4) a matching problem of the two-person passenger combination is solved, and a two-person pooling passenger matching scheme with an optimal total passenger travel time is obtained;
for any user i∈RP₂, he can only form a two-person passenger combination with another user j∈RP₂\{i} ultimately, with a goal of minimizing the total passenger travel time, while under the user's two-person pooling demand, the matching problem of the two-person passenger combination is transformed into a 0-1 programming model as follows:
$$min {\sum }_{i = 1}^{\vert {RP}_{2} \vert} {\sum }_{j = 1}^{\vert {RP}_{2} \vert} {r}_{\overline{ij}} {x}_{ij} \\ s . t . \{ \begin{matrix}{\sum }_{i = 1}^{\vert {RP}_{2} \vert} {x}_{ij} = 1 , ∀ j ∈ {RP}_{2} \\ {\sum }_{j = 1}^{\vert {RP}_{2} \vert} {x}_{ij} = 1 , ∀ i ∈ {RP}_{2} \\ {x}_{ij} = 0 or 1 , ∀ i , j ∈ {RP}_{2}\end{matrix}$$
where xᵢⱼ is a 0-1 variable: in a solution result of the model, if the user i and the user j constitute a two-person passenger combination {i, j}, then xᵢⱼ=1, otherwise xᵢⱼ=0;
furthermore, there is no constraint in the 0-1 programming model i≠j, and the shortest passenger travel time r_{i̅i̅} for repeating the two-person passenger combination {i, i} is set as follows:
$${r}_{\overline{ii}} = Inf , ∀ i ∈ R {P}_{2}$$
where Inf represents a positive infinite constant;
Hungarian algorithm is used to solve the 0-1 programming model, and an obtained solution vector is x=(xᵢⱼ, i∈RP₂, j∈RP₂)^{T}, the two-person passenger combination corresponding to xᵢⱼ=1 is screened out, the passenger combination set RP_{2_2} is formed, which is referred to as the main passenger combination set 2, a quantity of set elements of which is |RP_{2_2}|=|RP₂|/2; and
a set RC₂=RP_{2_2}∪{RP_{C2}} is allowed to represent the passenger combination set formed by the users with the two-person pooling demand, i.e. a union set of RP_{2_2} and {RP_{C2}}, the travel path and travel time of each passenger combination in the set RC₂ are recorded, and a quantity |RC₂| of set elements represents a quantity of the passenger combinations under the two-person pooling demand.

16. The computer system for passenger matching according to claim 14, wherein in the step 2), a process of matching a passenger combination within the user set RP_{A3} with a three-person pooling demand is such that:
1) the system cloud end server pre-supplements a certain quantity of virtual users on the basis of RP₃ to form a generalized user set RP_{E3}, wherein the user in RP₃ calculates the shortest passenger travel time and travel path of all possible two-person passenger combinations with himself as the first passenger, and returns a calculation result to the system cloud end server;
a quantity |RP₃|/3 of virtual users are pre-supplemented before passenger combination matching under the three-person pooling demand of the user, and the travel start points Oᵢ and the travel end server points Dᵢ of the virtual users are all virtual nodes; the virtual node does not exist in a real urban road network, and the distance to any real node is positively infinite, |RP₃|/3 virtual users constitute a virtual user set RP_{V3}, and a union set of the virtual user set RP_{V3} and RP₃ is the generalized user set RP_{E3}, namely RP_{E3}=RP₃∪RP_{V3}, Inf representing a positive infinite constant;
after the smart phone of the user i∈RP₃ receives the data file File3 sent by the cloud end server, the smart phone of the user i takes the user i as the first passenger to calculate the shortest travel path and travel time of the two-person passenger combination formed by the user i and any other user j∈RP₃\{i}, and returns a calculation result to the system cloud end server, and the calculation formula is as follows:
$${p}_{ij} = \{ {O}_{i} \to {O}_{j} \to {D}_{i} \to {D}_{j} , {O}_{i} \to {O}_{j} \to {D}_{j} \to {D}_{i} \} \\ {r}_{ij} = min \{ t ( {O}_{i} , {O}_{j} ) + t ( {O}_{j} , {D}_{i} ) + t ( {D}_{i} , {D}_{j} ) , t ( {O}_{i} , {O}_{j} ) + t ( {O}_{j} , {D}_{j} ) + t ( {D}_{j} , {D}_{i} ) \}$$
as stated above, taking the user i as the first passenger, i.e. taking the start point Oᵢ of the user i as a jumping-off place, so that the user i is the passenger gets aboard at first, the driver firstly receives the users i and j as the two passengers, and then send them to destinations respectively;
in the formula, in both Oᵢ→Oⱼ→Dᵢ→Dⱼ and Oᵢ→Oⱼ→Dⱼ→Dᵢ, paths are represented by nodes which are passed through successively, and all possible travel paths of the two-person passenger combination {i, j} are taken when the user i is the first passenger, and Pᵢⱼ represents a travel path set of the two-person passenger combination {i, j} when the user i is the first passenger, and t(Oᵢ, Oⱼ), t(Oⱼ, Dᵢ), t(Dᵢ, Dⱼ), t(Oⱼ, Dⱼ), and t(Dᵢ, Dⱼ) all represent travel time between two nodes in parentheses, t(Oᵢ, Oⱼ)+t(Oⱼ, Dᵢ)+t(Dᵢ, Dⱼ) and t(Oᵢ, Oⱼ)+t(Oⱼ, Dⱼ)+t(Dⱼ, Dᵢ) both represent possible travel time of the two-person passenger combination {i, j} when the user i is the first passenger, and rᵢⱼ represents a shortest passenger travel time of the two-person passenger combination {i, j} when the user i is the first passenger;
2) the system cloud end server compares the shortest passenger travel times when different users in respective two-person passenger combinations serve as the first passenger, and determines the shortest passenger travel time and travel path of each two-person passenger combination;
within the two-person passenger combination {i, j}, a sum of the shortest passenger travel times rᵢⱼ and rᵢⱼ with the user i and the user j as the first passenger are compared with each other, the shortest passenger travel time r_{i̅j̅} of the two-person passenger combination is determined, and a travel path corresponding to r_{i̅j̅} is recorded, wherein the formula is as follows:
$${r}_{\overline{ij}} = min \{ {r}_{ij} , {r}_{ji} \}$$
3) all the users within “secondary user set 3” RP_{B3}| are formed into a passenger combination RP_{C3}, and the shortest passenger travel time r_{C̅3̅} and travel path of the passenger combination are calculated;
if |RP_{B3}|≠0 under the user's “three-person pooling” demand, then |RP_{B3}|=1 or |RP_{B3}|=2, namely, there are 1 or 2 users in the “secondary user set” RP_{B3}, all the users in the set RP_{B3} are formed into a passenger combination represented by RP_{C3} referred to as “secondary passenger combination 3”, and r is allowed to represent the shortest passenger travel time of the passenger combination RP_{C3}, and {RP_{C3}} is allowed to represent a passenger combination set comprising only one element of the passenger combination RP_{C3} referred to as “secondary passenger combination set 3”;
if there is one user in the set RP_{B3}, the user is set to be m∈RP_{B3}, then the “secondary passenger combination 3” RP_{C3}={m}, the shortest passenger travel time r_{C̅3̅}=t(Oₘ, Dₘ) of RP_{C3} and a corresponding travel path is Oₘ→Dₘ;
if there are two users in the set RP_{B3}, represented as m₁, m₂∈RP_{B3}, then “secondary passenger combination 3” RP_{C3}={m₁, m₂} is a two-person passenger combination, and the shortest passenger travel time r_{C̅3̅} of RP_{C3} is the shortest passenger travel time [symbol] of the two-person passenger combination {m₁, m₂} and for [symbol] it is also necessary to first respectively calculate the shortest passenger travel times rₘ_{₁}ₘ_{₂} and rₘ_{₂}ₘ_{₁} with m₁ and m₂ as the first passenger, and then make comparison to obtain the shortest passenger travel time [symbol] of the two-person passenger combination {m₁, m₂}, and a travel path corresponding to [symbol] is recorded;
4) to solve a first passenger combination matching problem under the “three-person pooling” demand of the user, |RP_{E3}/2 generalized two-person passenger combinations is matched in the generalized user set RP_{E3}, and then real users in |RP₃|/2 real two-person passenger combinations and |RP₃|/2 mixed two-person passenger combinations are selected from the generalized two-person passenger combinations; real users and virtual users are collectively referred to as generalized users;
if the passengers i and j in the two-person passenger combination {i, j} are both real users, then {i, j} is taken as the real two-person passenger combination; if the passenger i in the two-person passenger combination {i, j} is a real user and the passenger j is a virtual user, or if the passenger i is a virtual user and the passenger j is a real user, then {i, j} is taken as the mixed two-person passenger combination; if the passengers i and j in the two-person passenger combination {i, j} are both virtual users, then {i, j} is taken as a virtual two-person passenger combination, while the real two-person passenger combination, the mixed two-person passenger combination and the virtual two-person passenger combination are collectively referred to as the generalized two-person passenger combination;
in the first passenger combination matching process under the three-person pooling demand of the user, |RP_{E3}|/2 generalized two-person passenger combinations are matched in the generalized user set RP_{E3}, and for any generalized user i∈RP_{E3}, the generalized two-person passenger combination can only be formed by him with another generalized user j∈RP_{E3}\{i}, and aiming at minimizing the total passenger travel time, the matching problem of the generalized two-person passenger combination can be transformed into a 0-1 programming model as follows:
$$min {\sum }_{i = 1}^{\vert {RP}_{E 3} \vert} {\sum }_{j = 1}^{\vert {RP}_{E 3} \vert} {r}_{\overline{ij}} {x}_{ij} \\ s . t . \{ \begin{matrix}{\sum }_{i = 1}^{\vert {RP}_{E 3} \vert} {x}_{ij} = 1 , ∀ j ∈ {RP}_{E 3} \\ {\sum }_{j = 1}^{\vert {RP}_{E 3} \vert} {x}_{ij} = 1 , ∀ i ∈ {RP}_{E 3} \\ {x}_{ij} = 0 or 1 , ∀ i , j ∈ {RP}_{E 3}\end{matrix}$$
where xᵢⱼ is a variable from 0 to 1; in a model solution result, if the generalized user i and the generalized user i constitute the generalized two-person passenger combination {i, j}, then xᵢⱼ=1, otherwise xᵢⱼ=0;
since there is no constraint i≠j in the 0-1 programming model, the 0-1 programming model not only has the repeated two-person passenger combination {i, i} and the related parameter r_{i̅i̅} and variable xᵢᵢ, but also has the virtual user and the mixed two-person passenger combination and the virtual two-person passenger combination which may be formed;
in order to match the real two-person passenger combination as much as possible, and at the same time enable the 0-1 programming model to solve the first passenger matching process of “three-person pooling”, Inf is allowed to represent a positive infinite constant, and the shortest passenger travel time of any generalized two-person passenger combination {i, j} is set as follows:
if i∈RP₃, j∈RP₃ and i≠j, it is the real two-person passenger combination, and the shortest passenger travel time thereof is r_{i̅j̅};
if i∈RP₃, j∈RP_{V3} or j∈RP₃, i∈RP_{V3}, it is the mixed two-person passenger combination, and the shortest passenger travel time thereof is Inf;
if i∈RP_{V3}, j∈RP_{V3} and i≠j, it is the virtual two-person passenger combination, and the shortest passenger travel time thereof is 2*Inf;
for the repeated two-person passenger combination {i, i}, the shortest passenger time r_{i̅i̅} thereof is set as 2*Inf;
the Hungarian algorithm is applied to solve the 0-1 programming model, and the solved vector is x=(xᵢⱼ, i∈RP_{E3}, j∈RP_{E3})^{T}, 2*(|RP₃|/3) generalized two-person passenger combinations corresponding to xᵢⱼ=1 are screened out, wherein there are |RP₃|/3 real two-person passenger combinations and |RP₃|/3 mixed two-person passenger combinations;

|RP₃|/3 real two-person passenger combinations are screened out to construct the real two-person passenger combination set RP_{3_2} and the quantity of set elements is |RP_{3_2}|=|RP₃|/3; then the real users in |RP₃|/3 mixed two-person passenger combinations are screened out to construct the user set RP_{3_1} and the quantity of set elements is |RP_{3_1}|=|RP₃|/3;
after the system cloud end server completes the first passenger combination matching of the three-person pooling, the start points and the end server points of two users of each real two-person passenger combination in the real two-person passenger combination set RP_{3_2} are extracted to form a data file File3_2; start points and end server points of each user in the user set RP_{3_1} are extracted to form a data file File3_1; after forming the data files, the system cloud sends the data files File3_1 and File3_2 to all the smart phones of the users in RP₃ again;
5) the user in RP₃ calculates a shortest passenger travel time and travel path of all possible three-person passenger combinations with himself as a first passenger, and returns a calculation result to the system cloud end server;
the real two-person passenger combination set RP_{3_2} and the user set RP_{3_1} are obtained in the first passenger combination matching process of the three-person pooling, so that the real two-person passenger combination {i, j}∈RP_{3_2} and the real user k∈RP_{3_1}, then the user i, the user j and the user k constitute a three-person passenger combination {i, j, k};
a step of calculating the shortest passenger travel time of the three-person passenger combination {i, j, k} is as follows; smart phones of the user i, j∈{i, j}, {i, j}∈RP_{3_2} and the user k∈RP_{3_1} receive the data files File3_1 and File3_2 sent by the cloud end server; after receiving the files File3_1 and File3_2, the smart phone of the user i takes the user i as the first passenger to calculate the shortest travel path and travel time of the three-person passenger combination formed by the user i, the user j and the user k, and returns a calculation result to the system cloud end server, and the calculation formula is as follows:
$${P}_{ijk} = \{ \begin{matrix}{O}_{i} \to {O}_{j} \to {O}_{k} \to {D}_{i} \to {D}_{j} \to {D}_{k} , \\ {O}_{i} \to {O}_{k} \to {O}_{j} \to {D}_{i} \to {D}_{j} \to {D}_{k} , \\ {O}_{i} \to {O}_{j} \to {O}_{k} \to {D}_{i} \to {D}_{k} \to {D}_{j} , \\ {O}_{i} \to {O}_{k} \to {O}_{j} \to {D}_{i} \to {D}_{k} \to {D}_{j} , \\ {O}_{i} \to {O}_{j} \to {O}_{k} \to {D}_{j} \to {D}_{i} \to {D}_{k} , \\ {O}_{i} \to {O}_{k} \to {O}_{j} \to {D}_{j} \to {D}_{i} \to {D}_{k} , \\ {O}_{i} \to {O}_{j} \to {O}_{k} \to {D}_{j} \to {D}_{k} \to {D}_{i} , \\ {O}_{i} \to {O}_{k} \to {O}_{j} \to {D}_{j} \to {D}_{k} \to {D}_{i} , \\ {O}_{i} \to {O}_{j} \to {O}_{k} \to {D}_{k} \to {D}_{i} \to {D}_{j} , \\ {O}_{i} \to {O}_{k} \to {O}_{j} \to {D}_{k} \to {D}_{i} \to {D}_{j} , \\ {O}_{i} \to {O}_{j} \to {O}_{k} \to {D}_{k} \to {D}_{j} \to {D}_{i} , \\ {O}_{i} \to {O}_{k} \to {O}_{j} \to {D}_{k} \to {D}_{j} \to {D}_{i}\end{matrix} \}$$
$${r}_{ijk} = min \{ \begin{matrix}t ( {O}_{i} , {O}_{j} ) + t ( {O}_{j} , {O}_{k} ) + t ( {O}_{k} , {D}_{i} ) + t ( {D}_{i} , {D}_{j} ) + t ( {D}_{j} , {D}_{k} ) , \\ t ( {O}_{i} , {O}_{k} ) + t ( {O}_{k} , {O}_{j} ) + t ( {O}_{j} , {D}_{i} ) + t ( {D}_{i} , {D}_{j} ) + t ( {D}_{j} , {D}_{k} ) , \\ t ( {O}_{i} , {O}_{j} ) + t ( {O}_{j} , {O}_{k} ) + t ( {O}_{k} , {D}_{i} ) + t ( {D}_{i} , {D}_{k} ) + t ( {D}_{k} , {D}_{j} ) , \\ t ( {O}_{i} , {O}_{k} ) + t ( {O}_{k} , {O}_{j} ) + t ( {O}_{j} , {D}_{i} ) + t ( {D}_{i} , {D}_{k} ) + t ( {D}_{k} , {D}_{j} ) , \\ t ( {O}_{i} , {O}_{j} ) + t ( {O}_{j} , {O}_{k} ) + t ( {O}_{k} , {D}_{j} ) + t ( {D}_{j} , {D}_{i} ) + t ( {D}_{i} , {D}_{k} ) , \\ t ( {O}_{i} , {O}_{k} ) + t ( {O}_{k} , {O}_{j} ) + t ( {O}_{j} , {D}_{j} ) + t ( {D}_{j} , {D}_{i} ) + t ( {D}_{i} , {D}_{k} ) , \\ t ( {O}_{i} , {O}_{j} ) + t ( {O}_{j} , {O}_{k} ) + t ( {O}_{k} , {D}_{j} ) + t ( {D}_{j} , {D}_{k} ) + t ( {D}_{k} , {D}_{i} ) , \\ t ( {O}_{i} , {O}_{k} ) + t ( {O}_{k} , {O}_{j} ) + t ( {O}_{j} , {D}_{j} ) + t ( {D}_{j} , {D}_{k} ) + t ( {D}_{k} , {D}_{i} ) , \\ t ( {O}_{i} , {O}_{j} ) + t ( {O}_{j} , {O}_{k} ) + t ( {O}_{k} , {D}_{k} ) + t ( {D}_{k} , {D}_{i} ) + t ( {D}_{i} , {D}_{j} ) , \\ t ( {O}_{i} , {O}_{k} ) + t ( {O}_{k} , {O}_{j} ) + t ( {O}_{j} , {D}_{k} ) + t ( {D}_{k} , {D}_{i} ) + t ( {D}_{i} , {D}_{j} ) , \\ t ( {O}_{i} , {O}_{j} ) + t ( {O}_{j} , {O}_{k} ) + t ( {O}_{k} , {D}_{k} ) + t ( {D}_{k} , {D}_{j} ) + t ( {D}_{j} , {D}_{i} ) , \\ t ( {O}_{i} , {O}_{k} ) + t ( {O}_{k} , {O}_{j} ) + t ( {O}_{j} , {D}_{k} ) + t ( {D}_{k} , {D}_{j} ) + t ( {D}_{j} , {D}_{i} )\end{matrix} \}$$
as stated above, in order to achieve the three-person pooling demand of the user, the driver first picks up the three passengers and then sends them to destinations respectively, where Pᵢⱼₖ represents a travel path set of the three-person passenger combination {i, j, k} when the user i is the first passenger, wherein the elements Oⱼ→Oᵢ→Oₖ→Dᵢ→Dⱼ→Dₖ are all paths, which are represented by nodes that are passed through successively, and rᵢⱼₖ represent the shortest passenger travel time of the three-person passenger combination {i, j, k} when the user i is the first passenger, while the elements t(Oₖ, Oⱼ)+t(Oⱼ, Oᵢ)+t(Oᵢ, Dᵢ)+t(Dᵢ, Dⱼ)+t(Dⱼ, Dₖ) all represent possible travel times of the three-person passenger combination {i, j, k};
6) the system cloud end server compares the shortest passenger travel times when different users in respective three-person passenger combinations serve as the first passenger, and determines the shortest passenger travel time and travel path of each three-person passenger combination;
within the three-person passenger combination {i, j, k}, the system compares the shortest passenger travel times rᵢⱼₖ, rⱼᵢₖ, and rₖᵢⱼ with the user i, the user j and the user k as the first passenger, determines the shortest passenger travel time r_{i̅j̅k̅} of the three-person passenger combination, and records a travel path corresponding to r_{i̅j̅k̅} and the formula is as follows:
$${r}_{\overline{ijk}} = min \{ {r}_{ijk} , {r}_{jik} , {r}_{kij} \}$$
7) a second passenger combination matching problem of three-person pooling is solved, and a three-person pooling passenger matching scheme with an optimal passenger travel time is obtained;
for any two-person passenger combination {i, j}∈RP_{3_2}, it can only form a three-person passenger combination with another user k∈RP_{3_1} ultimately, with a goal of minimizing the total passenger travel time, while under the user's three-person pooling demand, the matching problem of the two-person passenger combination can be transformed into a 0-1 programming model as follows:
$$min {\sum }_{\{ i , j \}} {\sum }_{k} {r}_{\overline{ijk}} {x}_{ijk}$$
$$s . t . \{ \begin{matrix}{\sum }_{\{ i , j \}} {x}_{ijk} = 1 , ∀ k ∈ {RP}_{3 \_ 1} \\ {\sum }_{k} {x}_{ijk} = 1 , ∀ \{ i , j \} ∈ {RP}_{3 \_ 2} \\ {x}_{ijk} = 0 or 1 , ∀ \{ i , j \} ∈ {RP}_{3 \_ 2} , k ∈ {RP}_{3 \_ 1}\end{matrix}$$
where xᵢⱼₖ is a variable from 0 to 1; in a solution result of the model, if the two-person passenger combination {i, j} and the user k constitute the three-person passenger combination {i, j, k}, then xᵢⱼₖ=1, otherwise xᵢⱼₖ=0;
Hungarian algorithm is used to solve the 0-1 programming model, and an obtained solution vector is x=(xᵢⱼₖ, {i,j}∈RP_{3_2}, k∈RP_{3_1})^{T}, the three-person passenger combination corresponding to xᵢⱼₖ=1 is screened out, the passenger combination set RP_{3_3} is constituted, which is referred to as the main passenger combination set 3, a quantity of set elements of which is |RP_{3_3}|=|RP₃|/3; and
a set RC₃=RP_{3_3}∪{RP_{C3}} is allowed to represent the passenger combination set formed by the users with the three-person pooling demand, i.e. a union set of RP_{3_3} and RP_{C3}, the travel path and travel time of each passenger combination in the set RC₃ are recorded, and a quantity |RC₃| of set elements represents a quantity of the passenger combinations under the three-person pooling demand; the set RC is allowed to represent a passenger combination set formed by all users in the system, which a union set of the passenger combination sets formed by users with two-passenger pooling demand and three-passenger pooling demand, that is RC=RC₂∪RC₃, a quantity |RC| of set elements represents a quantity of the passenger combinations in the system.

17. The computer system for passenger matching according to claim 16, wherein in the step 3), a process of matching the passenger combination within each passenger set is such that:
5.1) the passenger combination and the driver in the system are matched to form the driver-passenger combination, and a driver-passenger travel time and travel path of each driver-passenger combination are calculated;
5.2) a preset quantity of drivers or passenger combinations are supplemented, so that a quantity of passenger combinations participating in matching is equal to a quantity of drivers, a matching problem of the driver-passenger combination is solved, and a driver-passenger matching scheme with an optimal total driver-passenger travel time is obtained.

18. The computer system for passenger matching according to claim 17, wherein a method of the step 5.1) is as follows such that:
V is allowed to represent a driver set in the system, and a quantity |V| of set elements represents the quantity of drivers in the system;
for any driver v∈V, V_Oᵥ is allowed to represent a current position of v; for any passenger combination e∈RC, C_Oₑ and C_Dₑ are allowed to represent a start point and an end server point of a passenger combination travel path of e, and C_Tₑ represents a passenger combination travel time of e;
the driver v∈V and the passenger combination e∈RC are matched to constitute the driver-passenger combination {v, e} and a travel trajectory thereof is that the driver v starts from the current position V_Oᵥ to C_Oₑ for picking up the first passenger until C_Dₑ where all the passengers get off the vehicle;
pᵥₑ is allowed to represent a travel path of the driver-passenger combination {v, e}, and tᵥₑ is allowed to represent a path travel time of the driver-passenger combination {v, e}, i.e. a driver-passenger travel time, and the calculation formula is:
$${p}_{ve} = \{ {V\_O}_{v} \to {C\_O}_{e} \to {C\_D}_{e} \} \\ {t}_{ve} = t ( {V\_O}_{v} , {C\_O}_{e} ) + {C\_T}_{e}$$
where pᵥₑ represents a travel path from a current position V_Oᵥ to C_Dₑ by the driver, and t(V_Oᵥ, C_Oₑ) represents a travel time required by the driver u from the current position V_Oᵥ to the start point C_Oₑ of the travel path of the passenger combination e.

19. The computer system for passenger matching according to claim 18, wherein in the step 5.2), a method that a preset quantity of drivers or passenger combinations are supplemented so that a quantity of passenger combinations participating in matching is equal to a quantity of drivers is as follows such that:
a real driver and a virtual driver are collectively referred to as a generalized driver, and the real passenger combination and the virtual passenger combination are collectively referred to as the generalized passenger combination, and the generalized driver and the generalized passenger combination are matched and can form a generalized driver-passenger combination;
if the driver v in the driver-passenger combination {v, e} is the real driver and the passenger combination e is the real passenger combination, then {v, e} is a real driver-passenger combination; otherwise, {v, e} is a virtual driver-passenger combination, and the real driver-passenger combination and the virtual divisor-multiplier combination are collectively referred to as the generalized divisor-multiplier combination;
Inf is allowed to represent a positive infinite constant, a certain quantity of virtual drivers or virtual passenger combinations are supplemented according to actual situations, and a generalized driver set and a generalized passenger combination set are constructed, and the specific processing is as follows:
if a quantity of real passenger combinations is greater than a quantity of real drivers, namely |RC|>|V|, (|RC|−|V|) virtual drivers are supplemented in the driver set V to constitute the generalized driver set V_{g}, wherein the generalized passenger combination set RC_{g} is equal to the passenger combination set RC, namely RC_{g}=RC, with the driver-passenger travel time tᵥₑ=Inf of the virtual driver v and any generalized passenger combination e∈RC_{g};
if the quantity of real passenger combinations is less than the quantity of real drivers, namely |RC|<|V|, (|V|−|RC|) virtual passenger combinations are supplemented in the passenger combination set RC to constitute the generalized passenger combination set RC_{g}, the generalized driver set V_{g} is equal to the driver set V, namely V_{g}=V, with the driver-passenger travel time tᵥₑ=Inf of the virtual passenger combination e and any generalized driver v∈V_{g}.

20. The computer system for passenger matching according to claim 19, wherein for the generalized driver set and the generalized passenger combination set, a method for driver-passenger combination matching is as follows such that:
for any generalized driver v∈V_{g}, the generalized driver-passenger combination can only be formed by him with one generalized passenger combination e∈RC_{g}, and with a goal of minimizing the total driver-passenger travel time, the matching problem of the driver-passenger combination can be transformed into a 0-1 programming model as follows:
$$min {\sum }_{v = 1}^{\vert {V}_{g} \vert} {\sum }_{e = 1}^{\vert {RC}_{g} \vert} {t}_{ve} {y}_{ve} \\ s . t . \{ \begin{matrix}{\sum }_{e = 1}^{\vert {RC}_{g} \vert} {y}_{ve} = 1 , ∀ e ∈ {RC}_{g} \\ {\sum }_{v = 1}^{\vert {V}_{g} \vert} {y}_{ve} = 1 , ∀ v ∈ {V}_{g} \\ {y}_{ve} = 0 or 1 , ∀ e ∈ {RC}_{g} , v ∈ {V}_{g}\end{matrix}$$
where yᵥₑ is a variable from 0 to 1; in a model solution result, if the generalized driver v and the generalized passenger combination e constitute the generalized driver-passenger combination {v, e}, then yᵥₑ=1, otherwise yᵥₑ=0;
the Hungarian algorithm is applied to solve the 0-1 programming problem, and the obtained y=(yᵥₑ, v∈V_{g}, e∈RC_{g})^{T}, the generalized driver-passenger combinations solution vector is corresponding to yᵥₑ=1 therein are screened out to constitute a generalized driver-passenger combination set VRC_{g}, and then the real driver-passenger combinations in the set VRC_{g} are screened out to constitute a driver-passenger combination set VRC, wherein a quantity |VRC| of set elements is equal to a minimum value of a quantity |RC| of passenger combinations and a quantity |V| of drivers, namely |VRC|=min{|RC|, |V|}, and the travel path and travel time of each driver-passenger combination is recorded.
